(19) United States
(12) Patent Application Publication
(10) Pub. No.: US 2018/0280800 A1
(43) Pub. Date: Oct. 4, 2018

(54) COMPUTER-READABLE RECORDING MEDIUM AND SYSTEM

(71) Applicant: SQUARE ENIX CO., LTD., Tokyo (JP)

(72) Inventors: Sho FUJIKAWA, Tokyo (JP); Mizuki SAKUMA, Tokyo (JP); Takamasa SHIBA, Tokyo (JP)

(73) Assignee: SQUARE ENIX CO., LTD., Tokyo (JP)

(21) Appl. No.: 15/939,885

(22) Filed: Mar. 29, 2018

(30) Foreign Application Priority Data
Mar. 31, 2017 (JP) 2017-71171

(51) Int. Cl. A63F 13/58; A63F 13/35; A63F 13/69

(52) U.S. Cl. CPC A63F 13/58; A63F 13/69; A63F 13/35

(57) ABSTRACT

Provided is a game program in which a region attribute of at least one region, among a plurality of regions included in a game field, is changed during a competition game in accordance with the progression state of the game, an event is generated during the progress of the game, and the event is progressed in accordance with the number of regions having a predetermined region attribute or the area of the region.

### CROSS REFERENCE TO RELATED APPLICATION

The present disclosure relates to subject matter contained in Japanese Patent Application No. 2017-071171, filed on Mar. 31, 2017, the disclosure of which is expressly incorporated herein by reference in its entirety.

### BACKGROUND OF THE INVENTION

### Field of the Invention

The present invention relates to a computer-readable recording medium and a system.

### Description of Related Art

In recent years, there has been known a type of game referred to as a simulation Role Playing Game (RPG) in which a virtual battle is performed while acting on a game field by operating a character called a unit having a level. In the simulation RPG, the victory or defeat of the virtual battle is affected not only by the strength of the character but also by the position of the character. For example, in an official site of the “FINAL FANTASY TACTICS, The War of the Lions”, [online], [searched on Mar. 14, 2017], Internet (URL:http://www.square-enix.co.jp/fft/main_fft.html), it is disclosed that a success rate of an attack increases when an attack is made from the side or the back rather than when an attack is made from the front.

### SUMMARY OF INVENTION

### Technical Problem

In the above-described simulation RPG, in a case where the strength of a player's character is lower than that of an opponent player's character, it is not possible to win the virtual battle, as a matter of course. Even when both the characters have the same degree of strength, it is difficult to beat a character governing a position affecting the victory or defeat of the virtual battle. That is, in a case where it is apparent that the character is weaker than the opponent's character or a position affecting the victory or defeat of the virtual battle is governed, it is difficult for the player to come from behind and win a victory in spite of devising a strategy, and thus the player has no choice to give up a competition.

An object of at least one embodiment of the invention is to provide a strategic and highly interesting game program which allows a player to come from behind and win a victory even when the player is under unfavorable conditions.

### Solution to Problem

According to a non-limiting aspect, a non-transitory computer-readable recording medium including a game program for executing a competition game in a server apparatus which is communicatively connected to a computer apparatus including an input apparatus, the game program causing the server apparatus to function as: an attribute changer that changes a region attribute of at least one region among a plurality of regions included in a game field, in accordance with progression state of the game; an event generator that generates an event during the progress of the game; and an event processor that progresses the event in accordance with the number of regions having a predetermined region attribute or an area of the region.

According to a non-limiting aspect, a system comprising: a computer apparatus that includes an input apparatus; a server apparatus which is communicatively connected to the computer apparatus; an attribute changer that changes a region attribute of at least one region among a plurality of regions included in a game field, in accordance with progression state of a game; an event generator that generates an event during the progress of the game; and an event processor that progresses the event in accordance with the number of regions having a predetermined region attribute or an area of the region.

According to a non-limiting aspect, a non-transitory computer-readable recording medium including a game program for executing a competition game in a computer apparatus which includes an input apparatus and is communicatively connected to a server apparatus, wherein the server apparatus changes a region attribute of at least one region among a plurality of regions included in a game field in accordance with progression state of the game, generates an event during the progress of the game, and progresses the event in accordance with the number of regions having a predetermined region attribute or an area of the region and, the game program causing the computer apparatus to function as an operation instruction receiver that receives a player's operation instruction.

### Advantageous Effects of Invention

One or more of the above problems can be solved with each embodiment of the present invention.

### BRIEF DESCRIPTION OF THE DRAWINGS

FIG. 1 is a block diagram illustrating a configuration of a server apparatus, which corresponds to at least one embodiment of the invention.

FIG. 2 is a flow chart illustrating a program execution process, which corresponds to at least one embodiment of the invention.

FIG. 3 is a block diagram illustrating a configuration of a server apparatus, which corresponds to at least one embodiment of the invention.

FIG. 4 is a flow chart illustrating a program execution process, which corresponds to at least one embodiment of the invention.

FIG. 5 is a block diagram illustrating a configuration of a server apparatus, which corresponds to at least one embodiment of the invention.

FIG. 6 is a flow chart illustrating a program execution process, which corresponds to at least one embodiment of the invention.

FIG. 7 is a block diagram illustrating a configuration of a server apparatus, which corresponds to at least one embodiment of the invention.

FIG. 8 is a flow chart illustrating a program execution process, which corresponds to at least one embodiment of the invention.

FIG. 9 is a block diagram illustrating a configuration of a system, which corresponds to at least one embodiment of the invention.

FIG. 10 is a block diagram illustrating a configuration of a server apparatus, which corresponds to at least one embodiment of the invention.

FIG. 11 is a block diagram illustrating a configuration of a computer apparatus, which corresponds to at least one embodiment of the invention.

FIG. 12 is a diagram illustrating an example of a game execution screen, which corresponds to at least one embodiment of the invention.

FIGS. 13A to 13D are diagrams illustrating a rule of movement of an object, which corresponds to at least one embodiment of the invention.

FIGS. 14A and 14B are diagrams illustrating a securing of a region, which corresponds to at least one embodiment of the invention.

FIG. 15 is a flow chart illustrating a program execution process, which corresponds to at least one embodiment of the invention.

FIG. 16 is a flow chart illustrating an in-turn process, which corresponds to at least one embodiment of the invention.

FIGS. 17A to 17D are diagrams illustrating a case where regions have a predetermined positional relationship, which corresponds to at least one embodiment of the invention.

FIG. 18 is a diagram illustrating an example of a game execution screen, which corresponds to at least one embodiment of the invention.

FIG. 19 is a flow chart illustrating virtual battle processing, which corresponds to at least one embodiment of the invention.

FIG. 20 is a diagram illustrating an action master table, which corresponds to at least one embodiment of the invention.

FIG. 21 is a block diagram illustrating a configuration of a system, which corresponds to at least one embodiment of the invention.

FIG. 22 is a flow chart illustrating an execution process, which corresponds to at least one embodiment of the invention.

FIG. 23 is a block diagram illustrating a configuration of a computer apparatus, which corresponds to at least one embodiment of the invention.

FIG. 24 is a flow chart illustrating a program execution process, which corresponds to at least one embodiment of the invention.

FIG. 25 is a block diagram illustrating a configuration of a computer apparatus, which corresponds to at least one embodiment of the invention.

FIG. 26 is a flow chart illustrating a program execution process, which corresponds to at least one embodiment of the invention.

FIG. 27 is a flow chart illustrating a program execution process, which corresponds to at least one embodiment of the invention.

FIG. 28 is a flow chart illustrating an in-turn process, which corresponds to at least one embodiment of the invention.

FIG. 29 is a flow chart illustrating virtual battle processing, which corresponds to at least one embodiment of the invention.

### DESCRIPTION OF EMBODIMENTS

Hereinafter, embodiments of the invention will be described with reference to the accompanying drawings. Hereinafter, description relating to effects shows an aspect of the effects of the embodiments of the invention, and does not limit the effects. Further, the order of respective processes that form a flowchart described below may be changed in a range without contradicting or creating discord with the processing contents thereof.

### First Embodiment

An outline of a first embodiment of the invention will be described. Hereinafter, as the first embodiment of the invention, a description will be given of a game program for executing a competition game in a server apparatus which is communicatively connected to a computer apparatus including an input apparatus.

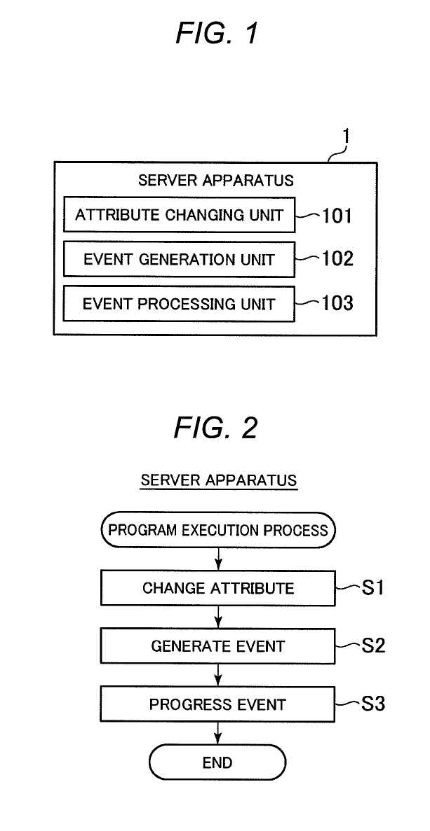

FIG. 1 is a block diagram illustrating a configuration of a server apparatus, which corresponds to at least one embodiment of the invention. A server apparatus 1 includes at least an attribute changing unit 101, an event generation unit 102, and an event processing unit 103.

The attribute changing unit 101 has a function of changing a region attribute of at least one region among a plurality of regions included in a game field, in accordance with the progress of a game. The event generation unit 102 has a function of generating an event during the progress of the game. The event processing unit 103 has a function of progressing the event in accordance with the number of regions having a predetermined region attribute or the area of the region.

A program execution process in the first embodiment of the invention will be described. FIG. 2 is a flow chart illustrating a program execution process, which corresponds to at least one embodiment of the invention.

The server apparatus 1 changes a region attribute of at least one region among a plurality of regions included in a game field, in accordance with the progress of a game (step S1). The server apparatus 1 generates an event during the progress of the game (step S2). The server apparatus 1 progresses the event in accordance with the number of regions having a predetermined region attribute or the area of the region (step S3), and finishes the game.

As an aspect of the first embodiment, it is possible to provide a strategic and highly interesting game by changing an attribute of a region in accordance with the progress of a game and progressing an event in accordance with the number of regions having a predetermined region attribute or the area of the region.

In the first embodiment, the “server apparatus” refers to, for example, an apparatus that executes processing in accordance with a request from the computer apparatus. The “computer apparatus” refers to, for example, a desktop or notebook personal computer, a tablet computer, a PDA, and the like, and may be a portable terminal including a touch panel sensor in a display screen. The “competition game” refers to, for example, a competition played with another person or a player controlled by a computer program in a computer game to be executed by starting up a program in the computer apparatus, and the genre of the game contents does not matter.

In the first embodiment, the “progress” refers to a parameter indicating progress at the present point in time in the entire game, information regarding a step indicating the state of the game, or information regarding a situation of an object disposed in a game space. The “field” refers to, for example, a space in the game. The “region” refers to, for example, an element constituting a portion of the game field, and the size and shape thereof do not matter. The “region attribute” refers to, for example, an attribute of the region, and is determined on the basis of a date and time when the region is governed, information regarding a player governing the region, history information of the player governing the region, or the like. Here, the “government” refers to, for example, association of the region with player information, and includes securing, occupation, obtainment, and the like. The “event” refers to, for example, an incident occurring in the game, and includes the achievement of an item, a battle with an enemy character, and the like.

### Second Embodiment

Next, an outline of a second embodiment of the invention will be described. Hereinafter, as the second embodiment of the invention, a description will be given of a game program for executing a competition game in a server apparatus which is communicatively connected to a computer apparatus including an input apparatus.

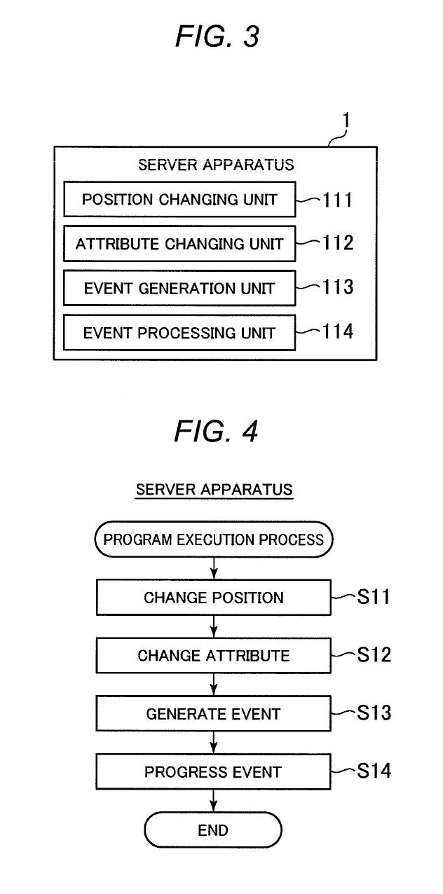

FIG. 3 is a block diagram illustrating a configuration of a server apparatus, which corresponds to at least one embodiment of the invention. A server apparatus 1 includes at least a position changing unit 111, an attribute changing unit 112, an event generation unit 113, and an event processing unit 114.

The position changing unit 111 has a function of changing the positions of objects including a player object associated with a player and an opponent's object playing a competition with the player object, which are present on a game field. The attribute changing unit 112 has a function of changing a region attribute of at least one region among a plurality of regions included in the game field, in accordance with the progress of the game. The event generation unit 113 has a function of generating an event during the progress of the game in a case where the player object and the opponent's object have a predetermined positional relationship. The event processing unit 114 has a function of progressing the event in accordance with the number of regions having a predetermined region attribute or the area of the region.

A program execution process in the second embodiment of the invention will be described. FIG. 4 is a flow chart illustrating a program execution process, which corresponds to at least one embodiment of the invention.

The server apparatus 1 changes the positions of objects including a player object which is associated with a player and an opponent's object playing a competition with the player object, which are present on a game field (step S11). The server apparatus 1 changes a region attribute of at least one region among a plurality of regions included in a game field, in accordance with the progress of the game (step S12).

The server apparatus 1 generates an event during the progress of the game in a case where the player object and the opponent's object have a predetermined positional relationship (step S13). The server apparatus 1 progresses the event in accordance with the number of regions having a predetermined region attribute or the area of the region (step S14), and finishes the game.

As an aspect of the second embodiment, it is possible to provide a more strategic and highly interesting game that has a function of changing the position of an object on a game field and is capable of selectively providing a timing when an event is caused to happen to a player by generating the event in a case where a player object and an opponent's object have a predetermined positional relationship.

In the second embodiment, with regard to each of the “server apparatus”, the “computer apparatus”, the “competition game”, the “progress”, the “field”, the “region”, the “region attribute”, and the “event”, it is possible to adopt contents described in the first embodiment in a necessary range.

In the second embodiment, the “object” is not particularly limited as long as the object is an object which is operatable in response to a player's operation instruction, and examples of the object include a character, an item, a vehicle such as a tank, and the like. The “opponent's object” refers to, for example, an object which plays a competition with a player object and is controlled by a human or by a computer.

### Third Embodiment

Next, an outline of a third embodiment of the invention will be described. Hereinafter, as the third embodiment of the invention, a description will be given of a game program for executing a competition game in a server apparatus which is communicatively connected to a computer apparatus including an input apparatus.

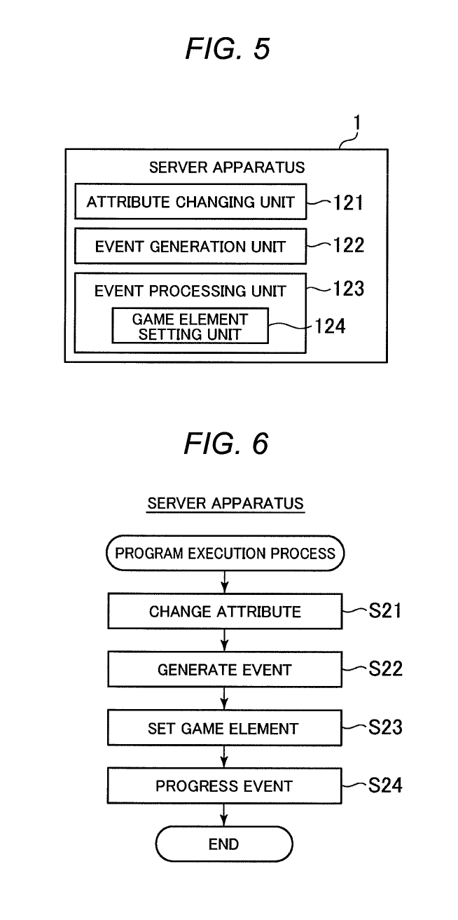

FIG. 5 is a block diagram illustrating a configuration of a server apparatus, which corresponds to at least one embodiment of the invention. A server apparatus 1 includes at least an attribute changing unit 121, an event generation unit 122, an event processing unit 123, and a game element setting unit 124.

The attribute changing unit 121 has a function of changing a region attribute of at least one region among a plurality of regions included in a game field, in accordance with the progress of a game. The event generation unit 122 has a function of generating an event during the progress of the game. The event processing unit 123 has a function of allowing an object on a game field to participate in the event and progressing the event in accordance with the number of regions having a predetermined region attribute or the area of the region. The game element setting unit 124 has a function of setting a game element which is used to determine whether or not an object can execute a predetermined action in the event, in accordance with the number of regions having a predetermined region attribute or the area of the region.

A program execution process in the third embodiment of the invention will be described. FIG. 6 is a flow chart illustrating a program execution process, which corresponds to at least one embodiment of the invention.

The server apparatus 1 changes a region attribute of at least one region among a plurality of regions included in a game field, in accordance with the progress of a game (step S21). The server apparatus 1 generates an event during the progress of the game (step S22). The server apparatus 1 sets a game element which is used to determine whether or not an object can execute a predetermined action in the event, in accordance with the number of regions having a predetermined region attribute or the area of the region. (step S23). The server apparatus 1 allows an object on a game field to participate in the event and progresses the event in accordance with the number of regions having a predetermined region attribute or the area of the region (step S24), and finishes the game.

As an aspect of the third embodiment, a configuration is adopted in which an object is allowed to participate in an event and a game element which is used to determine whether or not an object can execute a predetermined action in the event, in accordance with the number of regions having a predetermined region attribute or the area of the region, is set so that a player attends the event in consideration of the number of regions or the area of the region which is necessary for an action desired to be executed by the object in the event, and thus it is possible to provide a more strategic and highly interesting game.

In the third embodiment, with regard to each of the “server apparatus”, the “computer apparatus”, the “competition game”, the “progress”, the “field”, the “region”, the “region attribute”, and the “event”, it is possible to adopt contents described in the first embodiment in a necessary range.

In the third embodiment, with regard to the “object”, it is possible to adopt contents described in the second embodiment in a necessary range.

In the third embodiment, the “predetermined action” refers to, for example, an action which is executed by an object in an event and includes an attack against an enemy character, the use of a recovery magic for recovering a friend object, the use of an item, the purchase of an item in a store, and the like. The “game element” refers to, for example, an element which is used to determine whether or not an object can execute a predetermined action, and includes an element associated with the object, an element associated with the state of the game, and the like.

### Fourth Embodiment

Next, an outline of a fourth embodiment of the invention will be described. Hereinafter, as the fourth embodiment of the invention, a description will be given of a game program for executing a competition game in a server apparatus which is communicatively connected to a computer apparatus including an input apparatus.

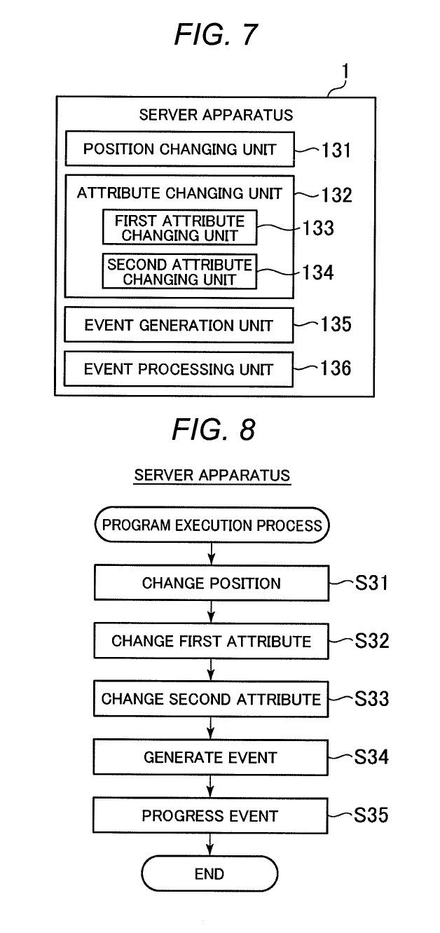

FIG. 7 is a block diagram illustrating a configuration of a server apparatus, which corresponds to at least one embodiment of the invention. A server apparatus 1 includes at least a position changing unit 131, an attribute changing unit 132, a first attribute changing unit 133, a second attribute changing unit 134, an event generation unit 135, and an event processing unit 136.

The position changing unit 131 has a function of changing the positions of objects including a player object associated with a player and an opponent's object associated with an opponent player, which are present on a game field. The attribute changing unit 132 has a function of changing a region attribute of at least one region among a plurality of regions included in a game field, in accordance with the progress of a game. The first attribute changing unit 133 has a function of changing a region attribute of a region corresponding to the position of the object which is changed by the position changing unit 131. The second attribute changing unit 134 has a function of changing a region attribute of a region having a region attribute different from the region attribute changed by the first attribute changing unit 133, in a case where the region satisfies a predetermined condition. The event generation unit 135 has a function of generating an event during the progress of the game. The event processing unit 136 has a function of progressing the event in accordance with the number of regions having a predetermined region attribute or the area of the region.

A program execution process in the fourth embodiment of the invention will be described. FIG. 8 is a flow chart illustrating a program execution process, which corresponds to at least one embodiment of the invention.

The server apparatus 1 changes the positions of objects including a player object associated with a player and an opponent's object associated with an opponent player, which are present on a game field (step S31). The server apparatus 1 changes a region attribute of a region corresponding to the position of the object which is changed in step S31 (step S32). The server apparatus 1 changes a region attribute of a region having a region attribute different from the region attribute changed in step S32, in a case where the region satisfies a predetermined condition (step S33). The server apparatus 1 generates an event during the progress of the game (step S34). The server apparatus 1 progresses the event in accordance with the number of regions having a predetermined region attribute or the area of the region (step S35), and finishes the game.

As an aspect of the fourth embodiment, a region attribute of a region corresponding to a position changed by the position changing unit 131 is changed by the first attribute changing unit 133, and a region attribute of a region having a region attribute different from the changed region attribute is changed by the second attribute changing unit 134 in a case where the region satisfies a predetermined condition, so that it is possible to give a strategic characteristic to the change of the region and to provide a strategic and highly interesting game.

In the fourth embodiment, with regard to each of the “server apparatus”, the “computer apparatus”, the “competition game”, the “progress”, the “field”, the “region”, the “region attribute”, and the “event”, it is possible to adopt contents described in the first embodiment in a necessary range. In the fourth embodiment, with regard to the “object”, it is possible to adopt contents described in the second embodiment in a necessary range.

In the fourth embodiment, the “predetermined condition” refers to, for example, a condition in which a region having a region attribute different from that of a region having a changed attribute and a region having the same region attribute as that of the region having a changed attribute have a predetermined positional relationship, a condition in which the region having a region attribute different from that of the region having a changed attribute and the region having the same region attribute as that of the region having a changed attribute are lined up in a predetermined order, or the like.

### Fifth Embodiment

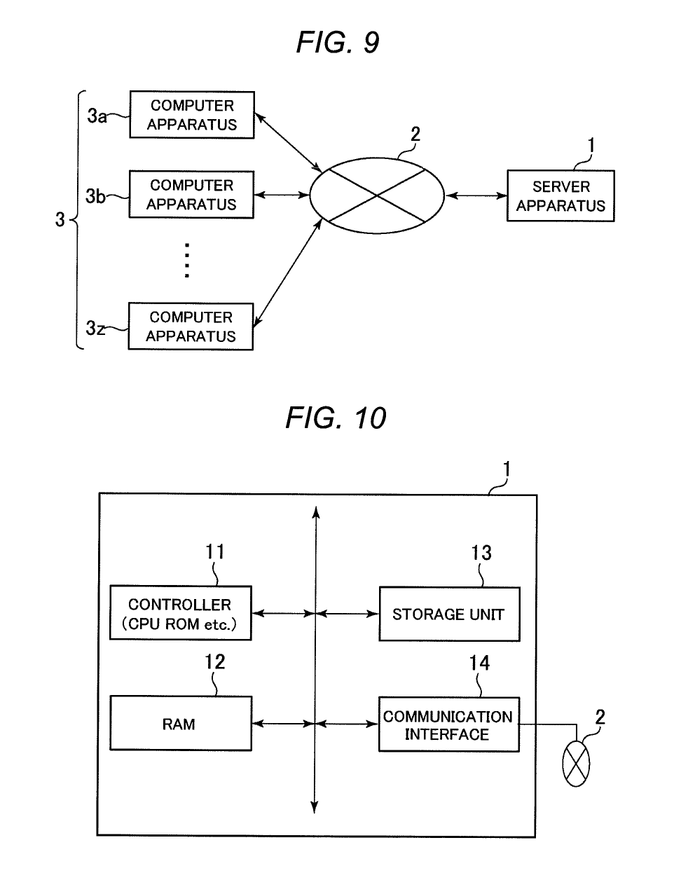

Next, an outline of a fifth embodiment of the invention will be described. Hereinafter, as the fifth embodiment of the invention, a description will be given of a game program for executing a competition game in a server apparatus which is communicatively connected to a computer apparatus including an input apparatus. FIG. 9 is a block diagram illustrating a configuration of a system, which corresponds to at least one embodiment of the invention. As illustrated in the drawing, the system is composed of a server apparatus 1, a communication network 2, and a plurality of computer apparatus 3 (computer apparatus 3a, 3b, . . . , and 3z) that are operated by plurality of users (user A, B, . . . , and Z). The computer apparatuses 1 are connected to the server apparatus 3 through the communication network 2. Meanwhile, the computer apparatuses 1 may be connected to the server apparatus 3 at all times or as necessary.

FIG. 10 is a block diagram illustrating a configuration of a server apparatus, which corresponds to at least one embodiment of the invention. A server apparatus 1 includes a controller 11, a RAM 12, a storage unit 13, and a communication interface 14, which are connected to each other through respective internal buses thereof.

The controller 11 is constituted by a CPU or a ROM, executes a program stored in the storage unit 13, and controls the server apparatus 1. In addition, the controller 11 includes an internal timer that clocks a time. The RAM 12 is a work area of the controller 11. The storage unit 13 is a storage region for storing programs and data. The controller 11 reads out the programs and the data from the RAM 12, and performs a program execution process on the basis of request information received from the computer apparatus 1. The communication interface 14 is communicatively connected to the communication network 2 in a wireless or wired manner, and may receive data via the communication network 2. The data received via the communication interface 14 is load in the RAM 12 and is subjected to calculation processing by the controller 11.

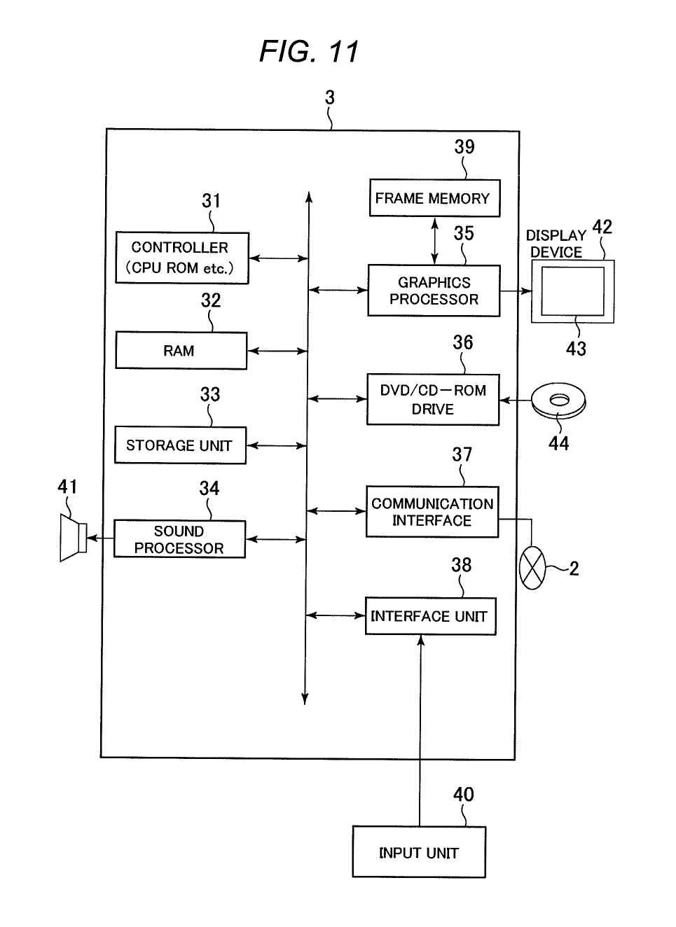

FIG. 11 is a block diagram illustrating a configuration of a computer apparatus, which corresponds to at least one embodiment of the invention. The computer apparatus 3 includes at least a controller 31, a Random Access Memory (RAM) 32, a storage unit 33, a sound processor 34, a graphics processor 35, a DVD/CD-ROM drive 36, a communication interface 37, and an interface unit 38. All of these are connected to each other by an internal bus.

The controller 31 is configured to include a Central Processing Unit (CPU) and a Read Only Memory (ROM). The controller 31 executes a program stored in the storage unit 33 or a recording medium 44 so as to control the computer apparatus 3. The controller 31 is also configured to include an inner timer that clocks time. The RAM 32 is a work area of the controller 31. The storage unit 33 is a storage area for storing a program and data.

The DVD/CD-ROM drive 36 may be adapted to a recording medium 44 which stores programs such as DVD-ROM and CD-ROM. A program and data, for example, are stored in the recording medium 44. The program and data are led out from the recording medium 44 with the DVD/CD-ROM drive 36 and are loaded to the RAM 32.

The controller 31 performs processing by reading the program and data from the RAM 32. The controller 31 processes the program and data which are loaded to the RAM 32, thereby outputting a sound command to the sound processor 34 and a drawing command to the graphics processor 35.

The sound processor 34 is connected to a sound output device 41 of a speaker. When the controller 31 outputs a sound command to the sound processor 34, the sound processor 34 outputs a sound signal to the sound output device 41.

The graphics processor 35 is connected to a display device 42. The display device 42 includes a display screen 43. When the controller 31 outputs a drawing command to the graphics processor 35, the graphics processor 35 decompresses images on a frame memory (frame buffer) 39, and then outputs a video signal to display images on the display screen 43. The graphics processor 35 draws one image in the unit of frames. For example, one frame time for the image is 1/30 seconds. The graphics processor 35 has a function of receiving a part of a calculation process relating to the drawing performed only by the controller 31 to disperse a load of the entire system.

An input unit 40 (such as a mouse and a keyboard) is connected to the interface unit 38. An input information by a user with respect to the input unit 40 is stored in RAM 32, and a various calculation processing is subjected by the controller 31 on the basis of the input information. A reader apparatus for a recording medium may be connected to the interface unit 38 to read in program and data and the like from a memory and the like. The display device 42 provided with a touch panel may also apply to as the input unit 40.

The communication interface 37 is communicatively connected to the communication network 2 in a wireless or wired manner, and may transmit and receive information with other computer apparatus.

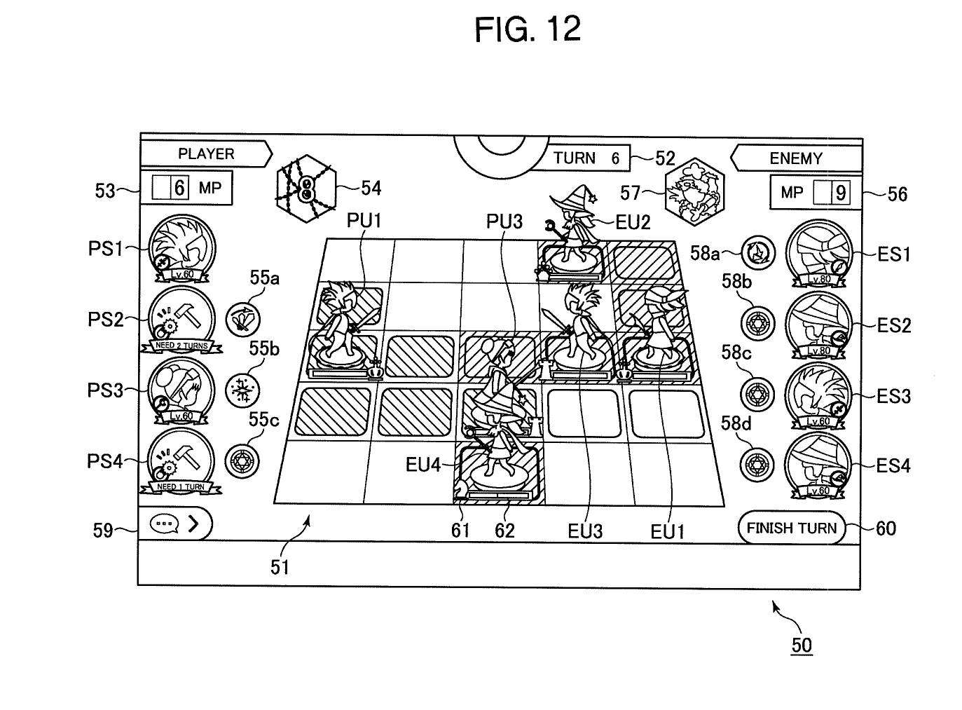

Next, a screen of a game in the fifth embodiment of the invention will be described. FIG. 12 is a diagram illustrating an example of a game execution screen, which corresponds to at least one embodiment of the invention.

### Game Outline

In the fifth embodiment, an example is a competition game in which a player object operated by a player and an opponent's object operated by another player play a competition while moving on a game field. As the competition game, it is possible to adopt a so-called turn-based battle which is progressed by a player and a opponent player alternately performing an operation instruction. A game finishing condition for finishing the competition game may be extermination of the opponent's object, defeat of an object having a predetermined attribute in an event, or the elapse of a predetermined time from the start of the game. In a case where the game is finished with the elapse of time, victory or defeat may be determined on the basis of information regarding an object which is present on the game field during the finishing of the game.

With regard to the game, another player who does not participate in the competition game can watch a situation in which the competition game is performed. For example, a game watcher supports the game, so that an item or the like for allowing players playing the competition to advantageously progress the competition may be provided.

### Game Execution Screen

A game screen 50 is displayed on the display screen 43 of the computer apparatus 3. A game field 51 is displayed in the middle of the game screen 50, and a present number of turns 52 of a competition game is displayed in the upper portion of the screen. The game field 51 is formed by a plurality of regions (squares). In the drawing, the game field is constituted by 5×5 squares, but the game field is not limited to the configuration shown in the drawing. In addition, the regions constituting the game field may have a triangular, circular, or hexagonal shape.

Information regarding an object associated with a player or a opponent player is displayed on the left and right sides of the game screen 50. Icons PS1 to PS4 and ES1 to ES4 indicate the state of an object associated with each player. In addition, MP 53 and MP 56 indicate points that are consumed when causing an object to execute a predetermined action in an event occurring during the execution of the competition game.

Each of causative objects 54 and 57 that are not disposed in the game field is a causative character associated with each player, and the causative object can use a skill corresponding to the causative character in a case where a predetermined number of turns pass and can affect the situation of the competition game. For example, the causative object 54 cannot use a skill because the predetermined number of turns have not passed. In order for the causative object 54 to use a skill, the number of turns corresponding to the displayed numerical value have to further pass. On the other hand, the causative object 57 can use a skill because the predetermined number of turns have passed. When the player is in his or her turn, the player can instruct the causative character to use a skill. The skills used by the causative objects 54 and 57 may be skills affecting the entire game field, or may be skills affecting some regions designated by the player.

Each of object skill buttons 55a to 55c and 58a to 58d can generate an effect corresponding to each object skill button in a case where a predetermined number of turns have passed, and can affect the situation of the competition game. The effect corresponding to the object skill button may change an effect exhibited in accordance with the position of the object.

A chatting button 59 can be pressed down or touched to display a window for chatting and to allow chatting with the opponent player or a game watcher in a chatting room. A turn finishing button 60 can be pressed down or touched to terminate a turn and to start an opponent's turn. That is, it is possible to skip the certain player's turn and to start the opponent's turn by pressing down the turn finishing button 60. Meanwhile, the finishing of the turn may be forcibly performed in a case where a predetermined time has elapsed from the start of the turn, rather than being performed by pressing down or touching the turn finishing button 60.

### Object

Subsequently, objects (units) disposed on the game field 51 will be described. The objects include a player object (PU1 and PU2 in FIG. 12) which is associated with a player and an opponent's object (EU1 to EU4 in FIG. 12) which is associated with an opponent player. In each object, a symbol 61 indicating a type and a vitality gauge 62 indicating the vitality (physical strength) of the object are displayed. When the vitality gauge 62 of the object is set to 0, the object is removed from the game field 51.

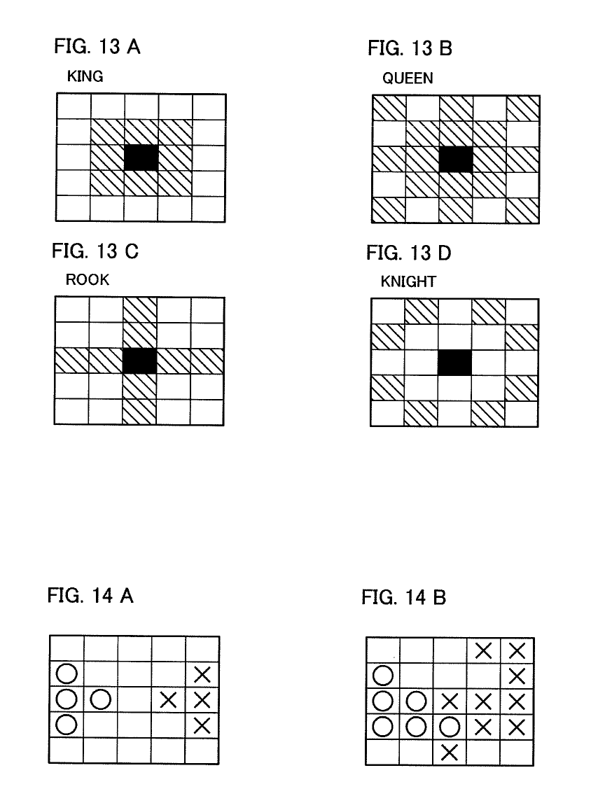

A region in which the object is movable may be determined in accordance with, for example, the rule of movement of types similar to chess, Shogi, game of Go, Reversi, Chaturanga, and other board games. As an example, a description will be given using king, queen, rook, knight, and the like which are classes of chess. FIGS. 13A to 13D are diagrams illustrating a rule of movement of an object, which corresponds to at least one embodiment of the invention. FIGS. 13A to 13D show a region to which an object of each class is movable. For example, FIG. 13A shows a region to which an object of a class of king is movable. In a case where the object of king is present in the center (black square) of 5×5 squares, a region movable from a starting point is a surrounding shaded square. Similarly, regarding queen, an object is movable to any square as long as the object is moved in the vertical direction and horizontal direction on the screen.

### Change of Region Attribute

Next, a region attribute which is an attribute of a region will be described. Attribute information is set in a region constituting the game field 51, and the region holds information regarding by which player the region is owned. In order to secure (hold) the region, an object may be moved to the region desired to be secured. However, the securing of the region is not permanently recognized, but a change as a region secured by an opponent player is made in a case where the opponent's object has been moved to a region secured by a player.

FIGS. 14A and 14B are diagrams illustrating a securing of a region, which corresponds to at least one embodiment of the invention. FIG. 14A is a diagram illustrating the game field 51 which is overlooked when a competition game is started. A mark ∘ indicates a region which is secured by a player, and a mark × indicates a region which is secured by an opponent player. An unmarked region is a region that does not belong to any player. In the initial state, a player object or an opponent's object is present in each of the regions with the mark ∘ and the mark ×.

On the other hand, FIG. 14B is a diagram illustrating a region in the situation illustrated in FIG. 12. When the competition game is progressed halfway as illustrated in FIG. 12, a region attribute is changed by the movement of each object. In FIG. 14B, both the mark ∘ and the mark × increase as compared to the beginning, and six marks ∘ and nine marks × are present. Meanwhile, MP 53 and MP 56 illustrated in FIG. 12 are determined in accordance with the number of marks ∘ and the number of marks × or the area thereof in FIGS. 14A and 14B, that is, the number of region attributes or the area thereof. With such a design, a player secures a large number of region attributes or a wide area, and thus it is possible to obtain means for defeating a strong opponent player and to provide a strategic and highly interesting game.

### Program Execution Process

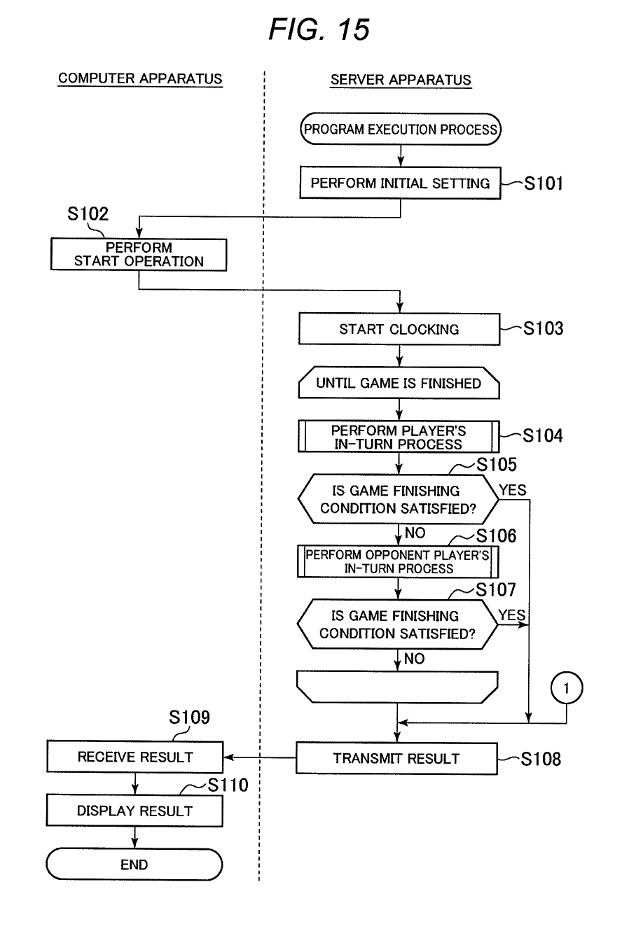

Next, a program execution process in the fifth embodiment of the invention will be described. FIG. 15 is a flow chart illustrating a program execution process, which corresponds to at least one embodiment of the invention.

First, when a program is executed, the server apparatus 1 performs initial setting for starting a game (step S101). The initial setting includes, for example, the construction of a virtual space for progressing the game, the setting of a chatting room, matching with an opponent player of a competition game, and the like. When the preparation for the competition game is made, the reception of a request from the computer apparatus 3 connected to the server apparatus 1 by communication is waited for.

The matching with the opponent player may be matching with a player having intimate ranking information, for example, on the basis of ranking information given in accordance with battle experience of the player. Alternatively, a system may be adopted in which a player sets up a room for a battle and widely advertises for an opponent player. Alternatively, matching with a player controlled by a computer may be performed.

The matching may be performed again after a competition, or a player setting up a room can continuously play a competition as long as the player continues to win a victory and a queue regarding a competition with the player may be generated, as in a so-called gunslinger system.

The player gives an operation instruction for starting a game to the computer apparatus 3 (step S102). The computer apparatus 3 transmits a start request instruction to the server apparatus 1.

The server apparatus 1 receives the start request from the computer apparatus 3. The server apparatus 1 starts clocking by using an internal timer included in the controller 11 (step S103).

Next, processing in the player's turn is performed in response to the player's operation instruction (step S104). When the player's turn is finished, the server apparatus 1 determines whether or not a game finishing condition is satisfied (step S105). In a case where the game finishing condition is satisfied (YES in step S105), the server apparatus 1 finishes the game without performing processing in an opponent player's turn. Processing during the finishing will be described later. In a case where the game finishing condition is not satisfied (NO in step S105), the server apparatus 1 performs processing in the opponent player's turn (step S106). When the opponent player's turn is finished, the server apparatus 1 determines whether or not the game finishing condition is satisfied (step S107). In a case where the game finishing condition is not satisfied (NO in step S107), the server apparatus 1 performs the processing in the player's turn again (step S104). The server apparatus 1 repeatedly performs the processes from step S104 to step S107 until the game finishing condition is satisfied. As an example of the game finishing condition, a physical strength value of an object having a predetermined attribute (for example, king) which is associated with the opponent player is set to be equal to or less than a predetermined threshold value.

When the game finishing condition is satisfied (YES in step S105 or step S107), the server apparatus 1 transmits a result of the competition game to the computer apparatus 3 (step S108). The computer apparatus 3 receives the result of the competition game (step S109). The computer apparatus 3 displays the result on the display screen 43 (step S110), and finishes the game.

### In-Turn Process

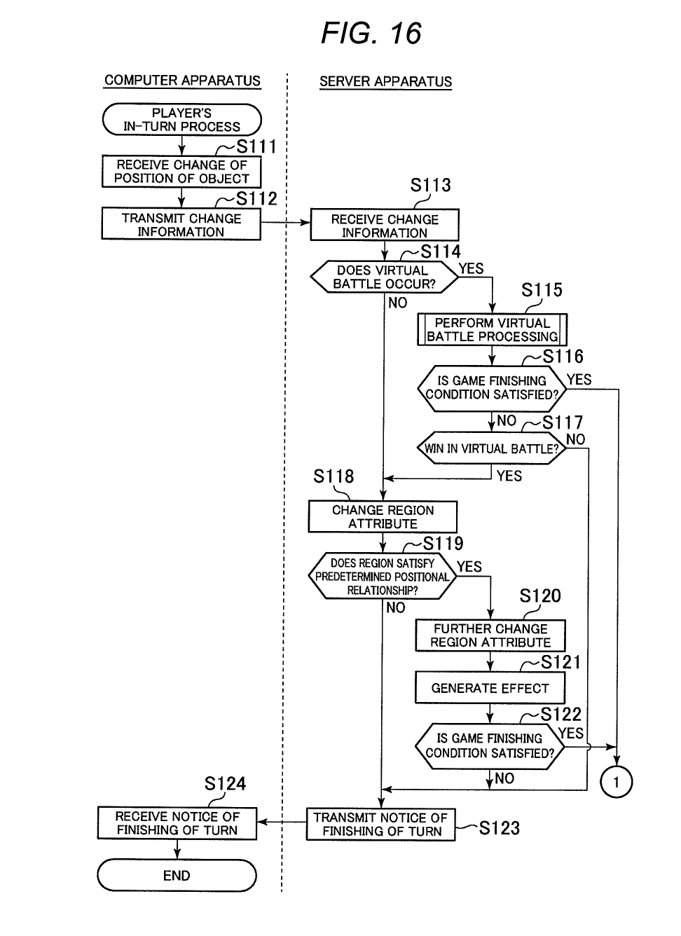

Next, an in-turn process in the fifth embodiment of the invention will be described. FIG. 16 is a flow chart illustrating an in-turn process, which corresponds to at least one embodiment of the invention. In the following description, processing in a turn on a player side is described, but the same processing can be adopted with respect to in an opponent player's turn processing.

First, the computer apparatus 3 receives a change regarding the position of an object from the player (step S111). That is, the player selects an object which is positioned on a game field and designates the position of a movement destination. The computer apparatus 3 transmits difference information from information regarding a state before the change and information regarding a state after the change to the server apparatus 1 as change information (step S112).

The server apparatus 1 receives the change information (step S113), and changes the situation of the game field. Here, when the object satisfies a predetermined condition, the server apparatus 1 determines whether or not a virtual battle occurs (step S114). For example, the predetermined condition is a condition in which a player object and an opponent's object have a predetermined positional relationship, and includes a case where the player object and the opponent's object are positioned in the same region by the change of the position of the object in step S111 and a case where the player object and the opponent's object are positioned in adjacent regions. Alternatively, a confirmation regarding whether to perform a virtual battle may be displayed after satisfying the predetermined positional relationship, and the virtual battle may be caused to occur in a case where the player desires the virtual battle.

In a case where the virtual battle occurs (YES in step S114), the server apparatus 1 performs virtual battle processing (step S115). Details of the virtual battle processing will be described later. When the virtual battle processing is finished, the server apparatus 1 determines whether or not a game finishing condition is satisfied (step S116). In a case where the game finishing condition is satisfied (YES in step S116), the server apparatus 1 transmits a result of the game to the computer apparatus 3 without performing the subsequent in-turn process (step S108), and finishes the game. In a case where the game finishing condition is not satisfied (NO in step S116), the server apparatus 1 determines whether or not the virtual battle is won (step S117). In a case where the virtual battle is won (YES in step S117), the server apparatus 1 removes the opponent's object from the game field. The server apparatus 1 changes a region attribute corresponding to the position after the change and secures the changed region attribute (step S118).

In a case where the virtual battle is not won, that is, in a case where the virtual battle ends in a draw or is lost (NO in step S117), the server apparatus 1 performs a process of finishing the turn. In a case where the virtual battle ends in a draw, the server apparatus 1 does not remove both the objects from the game field. In a case where the virtual battle is lost, the server apparatus 1 may remove the object on the side of the defeated player from the game field. The removed object may not be usable by the player until the competition game is finished, or a player on a winner side of the virtual battle may use the removed object, as in Shogi.

When regions are secured in step S118 by the change of the position or the winning of the virtual battle, the server apparatus 1 determines whether or not the regions satisfy the predetermined positional relationship (step S119).

### Reversi Effect

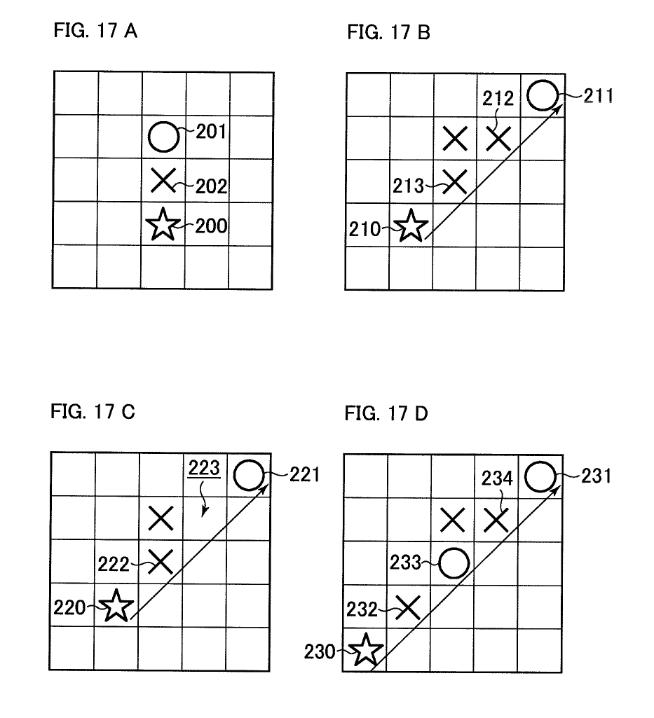

FIGS. 17A to 17D are diagrams illustrating a case where regions have a predetermined positional relationship, which corresponds to at least one embodiment of the invention. A mark ∘ in the drawing indicates a region associated with a player, and a mark × indicates a region associated with an opponent player. An unmarked region indicates a region which is not associated with any player. A mark ⋆ indicates a region in which an attribute is changed to the mark ∘ in step S118.

The predetermined positional relationship determined in step S119 refers to the setting of a state where a region having a region attribute different from a region having a changed attribute and a region having the same region attribute as that of the region having a changed attribute are linearly interposed. For example, in FIG. 17A, a changed region attribute of a region 200 is indicated by the mark ∘, and a region 202 having the mark × indicating a different region attribute is linearly interposed between the regions 200 and 201 indicated by the mark ∘. In such a state, the attribute of the region 202 indicated by the mark × is changed to the mark ∘ indicating the same region attribute as the changed region attribute of the region 200.

Subsequently, in FIG. 17B, regions 212 and 213 having an attribute, indicated by the mark ×, which is different from the changed region attribute of a region 210 are linearly interposed between the regions 210 and 211 indicated by the mark ∘. Therefore, the attributes of the regions 212 and 213 indicated by the mark × are changed to the mark ∘.

Subsequently, In FIG. 17C, a region 222 having an attribute, indicated by the mark ×, which is different from a changed region attribute of a region 220 is linearly interposed between the regions 220 and 221 having the mark ∘ through an unmarked region 223. However, in this case, it cannot be said that this state is an “interposed” state, and thus the attribute of the region 222 having the mark × is not changed.

Subsequently, in FIG. 17D, a region 232 having an attribute, indicated by the mark ×, which is different from a changed region attribute of a region 230 is linearly interposed between the regions 230 and 231 having the mark ∘ through a region 233 having the mark ∘ and a region 234 having the mark ×. In this case, the region 232 having the mark × is linearly interposed between the changed region 230 and the region 233 having the mark ∘. However, since the region 233 having the mark ∘ is present between the changed region 230 and the region 234 having the mark ×, the attribute of the region 232 having the mark × which is positioned between the changed region 230 and the region 233 having the mark ∘ is changed, and the attribute of the region 234 having the mark × is not changed.

Referring back to the flow chart of FIG. 16, in a case where it is determined that the region satisfies the predetermined positional relationship (YES in step S119), the server apparatus 1 further changes a region attribute of the region having the predetermined positional relationship (step S120). That is, in FIGS. 17A to 17D, a process of changing an attribute of a region indicated by the mark × interposed between the mark ∘ and the mark ⋆ to an attribute indicated by the mark ∘ is performed.

The region attribute changed in step S120 is an attribute different from the region attribute before the change. That is, the mark × may be changed to an attribute indicated by the mark ∘, or the mark × may be changed to an attribute which is not indicated by a mark.

Further, in a case where an opponent's object is present in a region having a changed attribute, the server apparatus 1 generates a predetermined effect (step S121). The predetermined effect may be a direct effect like an attack against an opponent's object, or may be an auxiliary effect such as a reduction in accuracy rate regarding the attack of the opponent's object. Alternatively, in a case where a friend object is present in the region having a changed attribute in step S121, the predetermined effect may be generated. In this case, a design may be made such that damage to the friend object is reduced or recovered.

Subsequently, the server apparatus 1 determines a game finishing condition on the basis of the effect generated in step S121 (step S122). In a case where the game finishing condition is satisfied (YES in step S122), the server apparatus 1 finishes the game without performing the subsequent processing. In a case where the game finishing condition is not satisfied (NO in step S122), the server apparatus 1 transmits a notice of the finishing of a turn to the computer apparatus 3 (step S123). The computer apparatus 3 receives the notice (step S124), and finishes the game. When the player's in-turn process is finished, the opponent player's in-turn process is started.

Meanwhile, in the above-described flow chart, a description is given of an example in which a player's turn is finished and transition to an opponent player's turn is performed when the position of one object is changed by the player and processing accompanied by the change is finished, but the invention is not limited thereto. For example, a round-based battle may be adopted in which positions are allowed to be changed with respect to all player objects in one turn and the turn is finished by pressing down or touching the turn finishing button 60 by the player.

### Virtual Battle

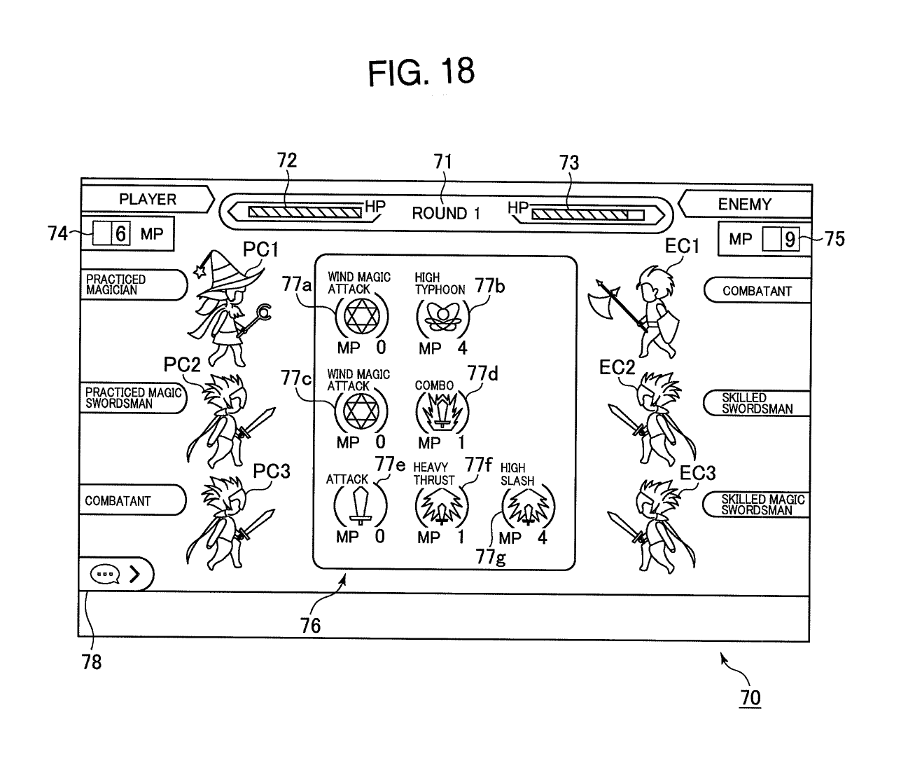

Subsequently, virtual battle processing will be described. FIG. 18 is a diagram illustrating an example of a game execution screen, which corresponds to at least one embodiment of the invention. In the fifth embodiment, an example is a virtual battle in which an action of an object is advanced by selecting an option representing a possible action displayed in a list. As the virtual battle, it is possible to adopt a so-called round-based battle which is progressed by a player and an opponent player alternately performing an operation instruction.

A virtual battle finishing condition for finishing the virtual battle may be making an attack against an opponent's object by the selected action to decrease a parameter of the opponent's object to a value equal to or less than a predetermined value or may be the passage of a predetermined time or turns from the start of the virtual battle. In a case where the game is finished with the elapse of time, the victory or defeat of the virtual battle may be determined on the basis of information regarding an object participating in the virtual battle during the finishing of the game. In addition, a time limit may be also set in a round so as to prompt the player to rapidly execute round processing.

### Virtual Battle Execution Screen

A game screen 70 is displayed on the display screen 43 of the computer apparatus 3. In the game screen 70, a present number of rounds 71 of a virtual battle is displayed in the upper portion of the screen. In addition, an object associated with a player and an object associated with an opponent player are respectively displayed on the left and right sides of the game screen 70. The object may be the same object as an object satisfying a predetermined positional relationship on a game field, or may be a plurality of child objects associated with the object. Alternatively, the virtual battle may be executed by collecting objects that are present in the vicinity of an object causing the virtual battle. An option display area 76 for displaying an option for causing an object to act by the player's selection is displayed in the middle of the game screen 70. In the option display area 76, as an example, options 77a to 77g associated with a child object are displayed as shown in the drawing.

Objects PC1, PC2 and PC3 associated with the player are displayed on the left side of the game screen 70. Objects EC1, EC2 and EC3 associated with the opponent player are displayed on the right side of the game screen 70. In addition, HP 72 and HP 73 which are elements for determining the victory or defeat of the virtual battle are calculated from parameters (a physical strength value, an endurance value, a mental strength value, and the like) of the child object. As an example, the HP may be set to be a total value of physical strength values of the child objects. In addition, MP 74 and MP 75 indicate points that are consumed when causing the child object to execute a predetermined action in the virtual battle.

A chatting button 78 is pressed down or touched to display a window for chatting. The chatting button allows chatting with the opponent player or a game watcher in a chatting room through the window for chatting and has the same function as that of the chatting button 59 in the competition game execution screen.

### Child Object

Subsequently, a child object which is used in a virtual battle will be described. The child object is associated with a player object associated with a player or is associated with an opponent's object associated with an opponent player. The child object has an attribute, and the attribute includes a job. A weapon, skill, or magic to be used and a selectable action vary depending on the job of the child object.

### Virtual Battle Process

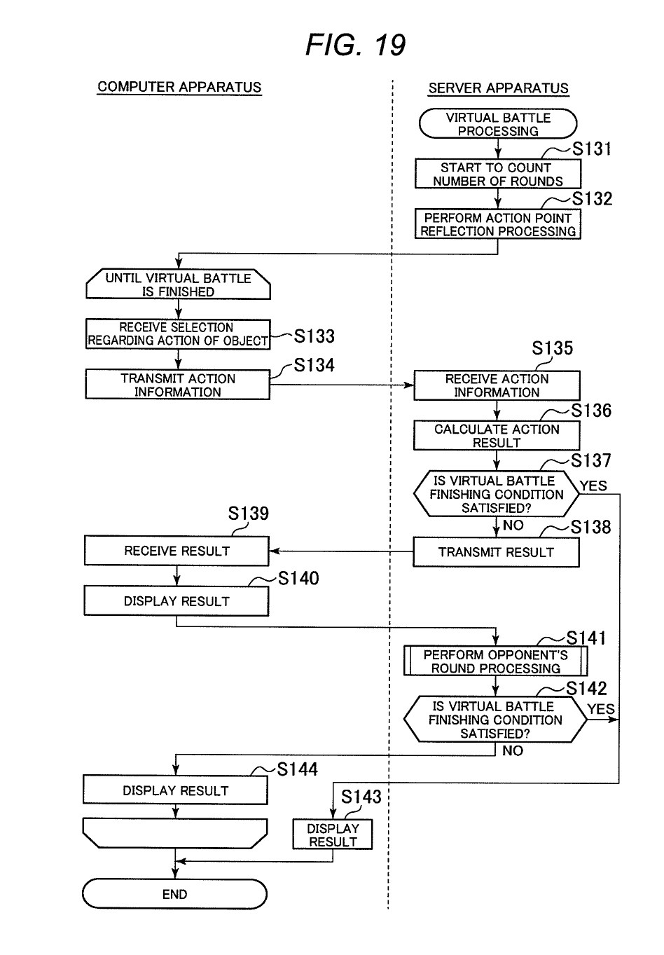

Next, virtual battle processing in the fifth embodiment of the invention will be described. FIG. 19 is a flow chart illustrating virtual battle processing, which corresponds to at least one embodiment of the invention.

First, when a program is executed, the server apparatus 1 starts to count the number of rounds (step S131). One round is finished when a player and an opponent player alternately perform an operation instruction. The server apparatus 1 reflects an action point, which is a game element used for determination regarding whether or not the child object acts, on a virtual battle screen (step S132). The action point fluctuates depending on the number of regions or the area of the region when the virtual battle is started. For example, in a case where the number of regions of the player is six, the MP 74 of the player is set to 6. Similarly, in a case where the number of regions of the opponent player is nine, the MP 75 is set to 9. As another example, a design may be made such that a reference value is determined for the player's MP and a number proportional to the number of regions or the area of the region when starting the virtual battle is added to the reference value of MP.

The computer apparatus 3 receives the player's selection regarding the action of the child object (step S133). An option regarding the action of the child object is determined in accordance with an attribute of the child object.

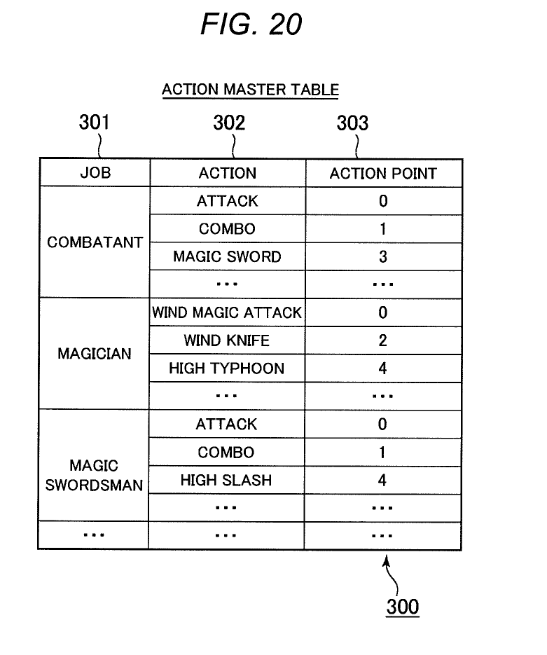

FIG. 20 is a diagram illustrating an action master table, which corresponds to at least one embodiment of the invention. In an action master table 300, an action point 303 is stored in association with a job 301 and an action 302. The action 302 associated with the job 301 corresponding to a job which is an attribute of a child object is a selectable action. Further, the action point reflected in step S132 and the action point 303, which is set for each action 302, are compared with each other to determine whether or not the action 302 can be executed and to set whether or not the action can be selected. For example, in a case where the job 301 of the child object is “magical swordsman” and the action 302 is “high slash”, the action point 303 is “4”. In a case where the action point reflected in step S132 is equal to or less than 3, “high slash” is set to be the impossibility of an action. When the action 302 is selected by the player's selection, the value of the action point 303 corresponding to the selected action 302 is subtracted from the MP 74 or 75.

Incidentally, in FIG. 20, whether or not an action is performed is determined in accordance with the action point reflected in step S132, but is not limited to the implementation mode. That is, the determination may be performed in accordance with the number of regions or the area of the region, without performing the reflection processing of step S132.

Subsequently, information regarding the action of the child object which is received in step S133 is transmitted to the server apparatus 1 (step S134). The server apparatus 1 receives the information regarding the action of the child object (step S135), and calculates a result of the action (step S136). In principle, the result of the action is calculated on the basis of parameters of the child object, but a design may be made such that a strong attack occurs in a case where a predetermined condition is satisfied.

Subsequently, the server apparatus 1 determines whether or not the action result calculated in step S136 satisfies a finishing condition for finishing the virtual battle (step S137). In a case where the action result satisfies the finishing condition (YES in step S137), the computer apparatus 3 displays a result of the virtual battle, which is received from the server apparatus 1, on the display screen 43 (step S143), and finishes the virtual battle. In a case where the action result does not satisfy the finishing condition (NO in step S137), the server apparatus 1 transmits the action result to the computer apparatus 3 (step S138). The computer apparatus 3 receives the action result from the server apparatus 1 (step S139). The action result is displayed on the display screen 43 of the computer apparatus 3 (step S140).

Subsequently, the processing proceeds to round processing of the opponent player (step S141). The round processing of the opponent player includes the processes from step S133 to step S140 which are performed by the opponent player's operation, and thus is omitted. When the round processing of the opponent player is finished, the server apparatus 1 determines whether or not the finishing condition for finishing the virtual battle is satisfied (step S142). In a case where the finishing condition is satisfied (YES in step S142), the computer apparatus 3 displays the result of the virtual battle, which is received from the server apparatus 1, on the display screen 43 (step S143), and finishes the virtual battle. In a case where the finishing condition is not satisfied (NO in step S142), the computer apparatus 3 displays the result of the virtual battle, which is received from the server apparatus 1, on the display screen 43 (step S144). The server apparatus 1 increments the number of rounds by one, and performs the processes from step S133 to step S144. The processes from step S133 to step S143 are repeatedly executed until the virtual battle is finished.

The virtual battle may be designed such that a preemptive attack can be performed in accordance with which player's turn a turn performed when starting the virtual battle is. For example, in a case where the virtual battle is started in the player's turn, it is possible to freely make an attack by one round as a preemptive attack, and round processing of a normal virtual battle is then executed. In this manner, the virtual battle can be advantageously progressed by the player who started the virtual battle, and thus it is possible to prevent a passive play in which the virtual battle is avoided on the game field.

### Communication System

In addition to the above-described competition game, it is possible to devise a method of enabling communication between a large number of players. In the initial setting of step S101, a room for performing a competition game is set, and another player can watch the situation of a competition.

In addition, a game watcher expects which player participating in the competition game wins the game, and may be able to bet, for example, virtual currency exchangeable for an item usable in the competition game. In this manner, in a case where the competition game is watched, it is possible to give a motivation to support a player who is playing a competition and is expected to win the game.

Further, in a case where a participating player can use an item for making the progress of the game advantageous in the competition game, the game watcher may be able to present the item during the competition. The game watcher can support the player who is playing the competition, and can affect the progress of the competition game. That is, the victory or defeat of the competition game does not depend on only the player's ability, and thus it is possible to further increase the interest of the game.

As an aspect of the fifth embodiment, a region attribute of a region having a predetermined positional relationship is further changed after the region attribute is changed, thereby generating a predetermined effect. Accordingly, it is possible to change the situation of a competition game in a mode different from that of a virtual battle, which makes it necessary for a player to plan a new strategy, and thus it is possible to provide a strategic and highly interesting game.

As an aspect of the fifth embodiment, an action of an object in a virtual battle is different for each attribute of an object, which makes it necessary for a player to perform a virtual battle in consideration of the action of the object, and thus it is possible to provide a strategic and highly interesting game.

As an aspect of the fifth embodiment, a region to which an object is movable is different for each class of an object, and thus it is possible to progress a competition game by combining rules of movement of objects of a plurality of classes and to provide a strategic and highly interesting game.

As an aspect of the fifth embodiment, an object having being defeated in a virtual battle is removed from a game field, and thus it is possible to greatly change the situation of a competition game and to provide a highly interesting game.

As an aspect of the fifth embodiment, in a case where a region having a region attribute different from that of a region having the changed attribute and a region having the same region attribute as that of the region having the changed attribute are linearly interposed, the region attribute of a region satisfying a predetermined condition may be changed to the same region attribute as that of the changed attribute, so that means for securing the regions can be provided as well as the movement of the object or the victory of the virtual battle, and thus a strategic and highly interesting game can be provided.

As an aspect of the fifth embodiment, a virtual battle is finished with the elapse of a predetermined time or predetermined rounds from the start of the virtual battle, and thus it is possible to smoothly progress a competition game without prolonging the virtual battle.

As an aspect of the fifth embodiment, in a case where a virtual battle is finished with the elapse of a predetermined time from the start of the virtual battle, an object is not removed from a game field. Accordingly, a player avoids the finishing of the virtual battle due to the elapse of time, and thus it is possible to give a motivation to avoid a passive action during the virtual battle.

As an aspect of the fifth embodiment, a reduction in parameters regarding an opponent's object is set to be a virtual battle finishing condition by an attack which is made against the opponent's object through an action of an object, and thus it is possible to give a motivation to more rapidly reduce parameters of the object than those of an opponent.

As an aspect of the fifth embodiment, a configuration is adopted in which an object is associated with a child object. Accordingly, a player can organize a team formed by a combination of a skill and magic of the child object, and it is possible to provide a strategic and highly interesting game.

As an aspect of the fifth embodiment, a parameter of an object is determined on the basis of a parameter of a child object, and thus it is possible to determine the strength of the object in accordance with a combination of child objects, to provide various combinations for each player, and to provide a strategic and highly interesting game.

As an aspect of the fifth embodiment, a competition game is progressed while alternately repeating the change of positions of a player object and an opponent's object, which results in necessity to foresee an opponent's next move, and thus it is possible to provide a strategic and highly interesting game.

As an aspect of the fifth embodiment, a special effect which is a particular effect is generated in a case where alternative repetition of the change of positions of a player object and an opponent's object is performed a predetermined number of times, and thus it is possible to provide means for changing the situation of a competition other than a virtual battle and to provide a strategic and highly interesting game.

As an aspect of the fifth embodiment, a game is finished by setting a parameter of an opponent's object having a predetermined object attribute to equal to or less than a predetermined value, and thus it is possible to give a player a motivation to act with an object having a predetermined attribute as an attack target.

As an aspect of the fifth embodiment, an action of an object in a virtual battle is set to be selectable in accordance with the number of regions having a predetermined region attribute or the area of the region, and thus it is possible to give a player a motivation to secure a large number of regions before executing the virtual battle. In addition, a player securing a large number of regions or a region having a wide area can execute a strong action in the virtual battle, which leads to a possibility that the player wins a victory even under a disadvantageous situation, and thus it is possible to provide a strategic and highly interesting game to the player.

As an aspect of the fifth embodiment, a player object and an opponent's object having a predetermined positional relationship participate in a virtual battle, and an action of the player object and/or the opponent's object is set to be selectable in accordance with the number of regions or the area of the region. Accordingly, it is possible to strategically determine an object participating in the virtual battle, and to provide a strategic and highly interesting game in which, for example, an object is involved, having a predetermined object attribute determined under game finishing conditions.

In the fifth embodiment, with regard to each of the “server apparatus”, the “computer apparatus”, the “competition game”, the “progress”, the “field”, the “region”, the “region attribute”, and the “event”, it is possible to adopt contents described in the first embodiment in a necessary range. With regard to each of the “object”, and the “opponent's object”, it is possible to adopt contents described in the second embodiment in a necessary range. With regard to each of the “predetermined action” and the “game element”, it is possible to adopt contents described in the third embodiment in a necessary range.

In the fifth embodiment, the “object attribute” refers to, for example, an attribute of an object, and refers to an attribute indicating information regarding the ability or parameter of the object. The “child object” refers to, for example, an object associated with an object. More specifically, a child object is a combatant riding in a vehicle as long as an object is the vehicle, and a child object is a general belonging to an army as long as an object is the army. The “special effect” refers to, for example, an effect different from a normal effect, and refers to an effect generated in a case where a predetermined condition is satisfied.

### Sixth Embodiment

Next, an outline of a sixth embodiment of the invention will be described. Hereinafter, as the sixth embodiment of the invention, a description will be given of a system including a computer apparatus having an input apparatus, and a server apparatus which is communicatively connected to the computer apparatus.

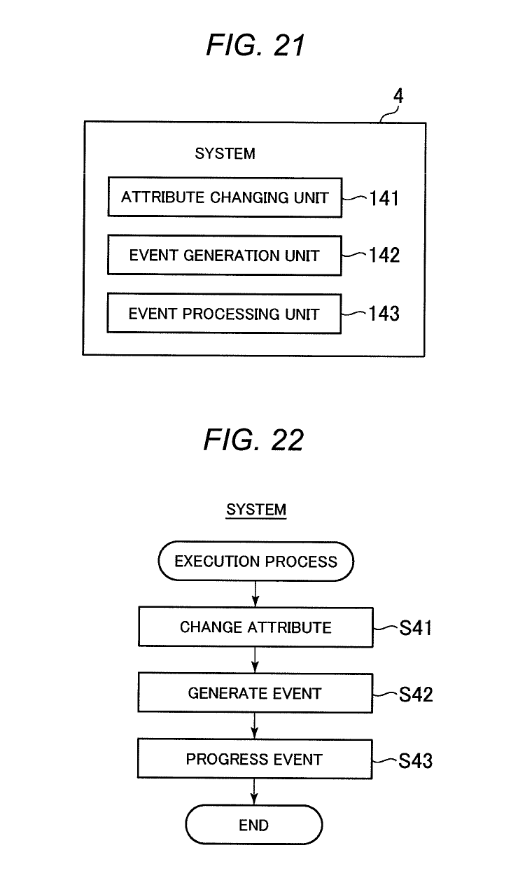

FIG. 21 is a block diagram illustrating a configuration of a system, which corresponds to at least one embodiment of the invention. A system 4 includes at least an attribute changing unit 141, an event generation unit 142, and an event processing unit 143.

The attribute changing unit 141 has a function of changing a region attribute of at least one region among a plurality of regions included in a game field, in accordance with the progress of a game. The event generation unit 142 has a function of generating an event during the progress of the game. The event processing unit 143 has a function of progressing the event in accordance with the number of regions having a predetermined region attribute or the area of the region.

An execution process in the sixth embodiment of the invention will be described. FIG. 22 is a flow chart illustrating an execution process, which corresponds to at least one embodiment of the invention.

The system 4 changes a region attribute of at least one region among a plurality of regions included in a game field, in accordance with the progress of a game (step S41). The system 4 generates an event during the progress of the game (step S42). The system 4 progresses the event in accordance with the number of regions having a predetermined region attribute or the area of the region (step S43), and finishes the game.

As an aspect of the sixth embodiment, it is possible to provide a strategic and highly interesting game by changing an attribute of a region and progressing an event in accordance with the number of regions having a predetermined region attribute or the area of the region.

In the sixth embodiment, with regard to each of the “server apparatus”, the “computer apparatus”, the “competition game”, the “progress”, the “field”, the “region”, the “region attribute”, and the “event”, it is possible to adopt contents described in the first embodiment in a necessary range. In the sixth embodiment, the “system” refers to, for example, a combination of hardware, software, a network, and the like.

### Seventh Embodiment

Next, an outline of a seventh embodiment of the invention will be described. Hereinafter, as the seventh embodiment of the invention, a description will be given of a game program for executing a competition game in a computer apparatus which includes an input apparatus and is communicatively connected to a server apparatus.

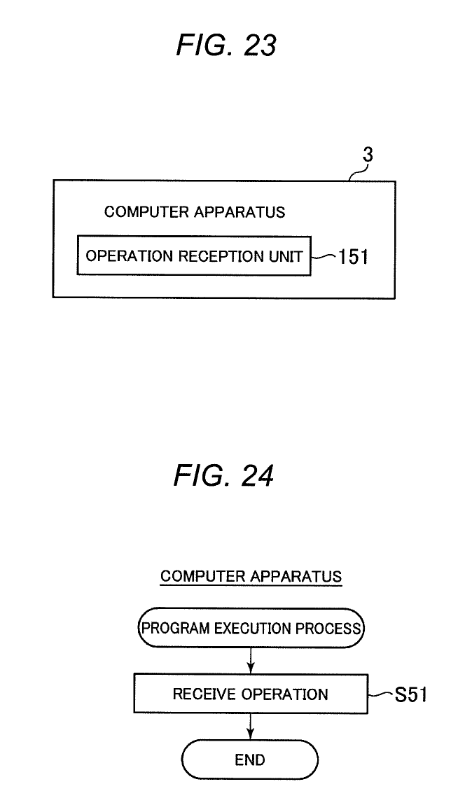

FIG. 23 is a block diagram illustrating a configuration of a computer apparatus, which corresponds to at least one embodiment of the invention. A computer apparatus 3 includes at least an operation reception unit 151. The operation reception unit 151 has a function of receiving a player's operation instruction.

A program execution process in the seventh embodiment of the invention will be described. FIG. 24 is a flow chart illustrating a program execution process, which corresponds to at least one embodiment of the invention.

The server apparatus changes a region attribute of at least one region among a plurality of regions included in a game field in accordance with the progress of the game, generates an event during the progress of the game, and progresses the event in accordance with the number of regions having a predetermined region attribute or the area of the region. The computer apparatus 3 receives a player's operation instruction (step S51), and finishes the game.

As an aspect of the seventh embodiment, it is possible to provide a strategic and highly interesting game by changing an attribute of a region and progressing an event in accordance with the number of regions having a predetermined region attribute or the area of the region.

In the seventh embodiment, with regard to each of the “server apparatus”, the “computer apparatus”, the “competition game”, the “progress”, the “field”, the “region”, the “region attribute”, and the “event”, it is possible to adopt contents described in the first embodiment in a necessary range.

### Eighth Embodiment

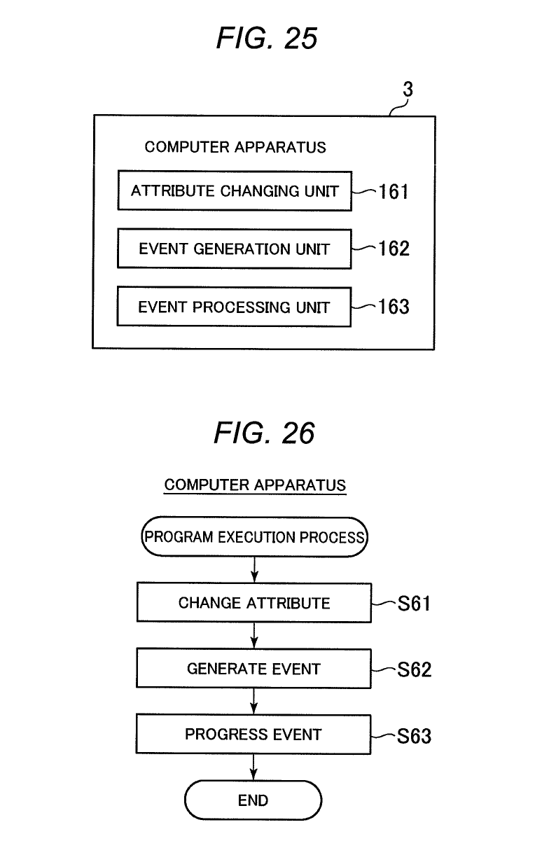

Next, an outline of an eighth embodiment of the invention will be described. Hereinafter, as the eighth embodiment of the invention, a description will be given of a game program for executing a competition game in a computer apparatus including an input apparatus. FIG. 25 is a block diagram illustrating a configuration of a computer apparatus, which corresponds to at least one embodiment of the invention. A computer apparatus 3 includes at least an attribute changing unit 161, an event generation unit 162, and an event processing unit 163.

The attribute changing unit 161 has a function of changing a region attribute of at least one region among a plurality of regions included in a game field, in accordance with the progress of a game. The event generation unit 162 has a function of generating an event during the progress of the game. The event processing unit 163 has a function of progressing the event in accordance with the number of regions having a predetermined region attribute or the area of the region.

A program execution process in the eighth embodiment of the invention will be described. FIG. 26 is a flow chart illustrating a program execution process, which corresponds to at least one embodiment of the invention.

The computer apparatus 3 changes a region attribute of at least one region among a plurality of regions included in a game field, in accordance with the progress of the game (step S61). The computer apparatus 3 generates an event during the progress of the game (step S62). The computer apparatus 3 progresses the event in accordance with the number of regions having a predetermined region attribute or the area of the region (step S63), and finishes the game.

As an aspect of the eighth embodiment, it is possible to provide a strategic and highly interesting game by changing an attribute of a region and progressing an event in accordance with the number of regions having a predetermined region attribute or the area of the region.

In the eighth embodiment, with regard to each of the “competition game”, the “computer apparatus”, the “progress”, the “field”, the “region”, the “region attribute”, and the “event”, it is possible to adopt contents described in the first embodiment in a necessary range.

### Ninth Embodiment

Next, an outline of a ninth embodiment of the invention will be described. Hereinafter, as the ninth embodiment of the invention, a description will be given of a game program for executing a competition game in a computer apparatus including an input apparatus. With regard to a configuration of a system of the ninth embodiment, a configuration illustrated in the block diagram of FIG. 9 can be adopted in a necessary range. With regard to a configuration of the computer apparatus, a configuration illustrated in FIG. 11 can be adopted in a necessary range.

With regard to an outline of a competition game, it is possible to adopt the competition game, described in the fifth embodiment, in which a competition is played while moving a player object operated by a player and an opponent's object operated by another player on a game field. A game finishing condition for finishing the competition game may be extermination of the opponent's object, defeat of an object having a predetermined attribute in an event, or the elapse of a predetermined time from the start of the game. In a case where the game is finished with the elapse of time, victory or defeat may be determined on the basis of information regarding an object which is present on the game field during the finishing of the game.

With regard to a game execution screen in the ninth embodiment of the invention, it is possible to adopt contents described in FIG. 12 in a necessary range. In addition, with regard to an object, it is possible to adopt contents described in the fifth embodiment in a necessary range. With regard to the rule of movement of the object, it is possible to adopt contents described in FIG. 13 in a necessary range. With regard to the change of a region attribute, it is possible to adopt contents described in the fifth embodiment and FIG. 14 in a necessary range.

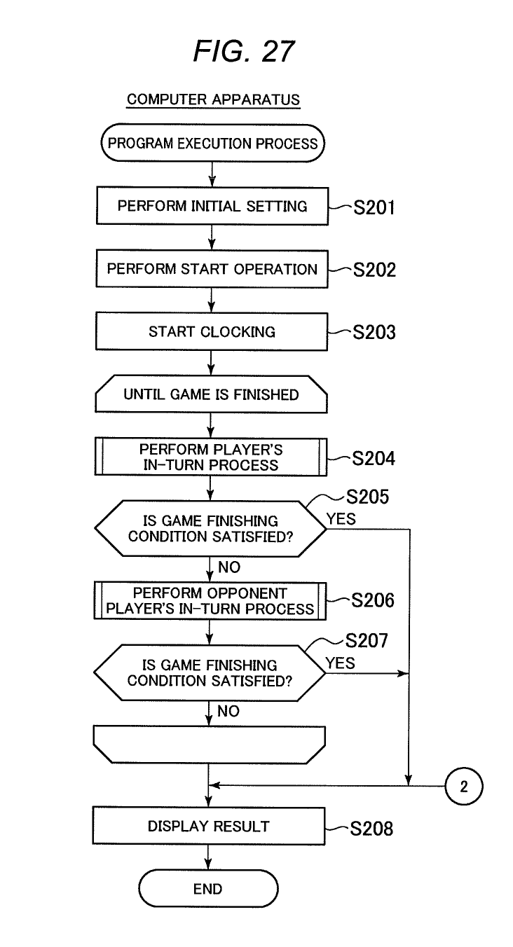

Next, a program execution process in the ninth embodiment of the invention will be described. FIG. 27 is a flow chart illustrating a program execution process, which corresponds to at least one embodiment of the invention.

First, when a program is executed, a computer apparatus 3 performs initial setting for starting a game (step S201). The initial setting includes, for example, the construction of a virtual space for progressing the game, the setting of a chatting room, matching with a opponent player of a competition game, and the like.

The matching with the opponent player may be matching with a player who has intimate ranking information and is controlled by a computer, for example, on the basis of ranking information given in accordance with battle experience of the player.

The player gives an operation instruction for starting a game to the computer apparatus 3 (step S202). The computer apparatus 3 starts clocking by using an internal timer included in a controller 31 (step S203).

The computer apparatus 3 receives the player's operation instruction to perform processing in the player's turn (step S204). When the player's turn is finished, the computer apparatus 3 determines whether or not a game finishing condition is satisfied (step S205). In a case where the game finishing condition is satisfied (YES in step S205), the computer apparatus 3 finishes the game without performing processing in an opponent player's turn. Processing during the finishing will be described later. In a case where the game finishing condition is not satisfied (NO in step S205), the computer apparatus 3 performs processing in the opponent player's turn (step S206). When the opponent player's turn is finished, the computer apparatus 3 determines whether or not the game finishing condition is satisfied (step S207). In a case where the game finishing condition is not satisfied (NO in step S207), the computer apparatus 3 performs the processing in the player's turn again (step S204). The processes from step S204 to step S207 are repeatedly performed until the game finishing condition is satisfied. As an example of the game finishing condition, a physical strength value of an object having a predetermined attribute (for example, king) which is associated with the opponent player is set to be equal to or less than a predetermined threshold value.

When the game finishing condition is satisfied (YES in step S205 or step S207), the computer apparatus 3 displays a result of the competition game on a display screen 43 (step S208), and finishes the game.

### In-Turn Process

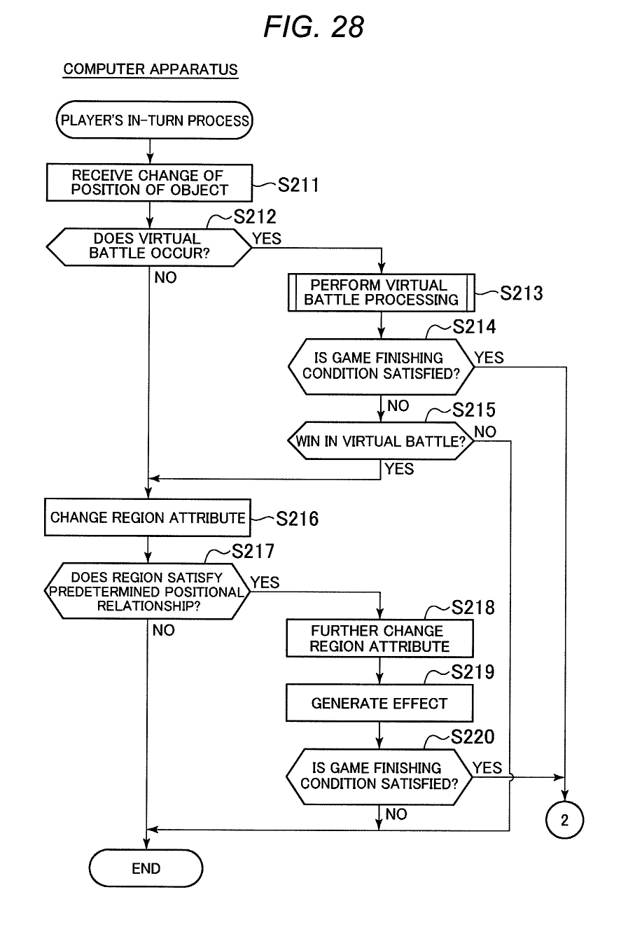

Next, an in-turn process in the ninth embodiment of the invention will be described. FIG. 28 is a flow chart illustrating an in-turn process, which corresponds to at least one embodiment of the invention. In the following description, processing in a turn on a player side is described, but the same processing can be adopted with respect to in an opponent player's turn processing.

First, the computer apparatus 3 receives a change regarding the position of an object from the player (step S211). That is, the player selects an object which is positioned on a game field and designates the position of a movement destination. Here, when the object satisfies a predetermined condition, the computer apparatus 3 determines whether or not a virtual battle occurs (step S212). the predetermined condition is a condition in which a player object and an opponent's object have a predetermined positional relationship, and includes a case where the player object and the opponent's object are positioned in the same region by the change of the position of the object in step S211 and a case where the player object and the opponent's object are positioned in adjacent regions. Alternatively, a confirmation regarding whether to perform a virtual battle may be displayed after satisfying the predetermined positional relationship, and the virtual battle may be caused to occur in a case where the player desires the virtual battle.

In a case where the virtual battle occurs (YES in step S212), the computer apparatus 3 performs virtual battle processing (step S213). Details of the virtual battle processing will be described later. When the virtual battle processing is finished, the computer apparatus 3 determines whether or not a game finishing condition is satisfied (step S214). In a case where the game finishing condition is satisfied (YES in step S214), the computer apparatus 3 finishes the game without performing the subsequent in-turn process. In a case where the game finishing condition is not satisfied (NO in step S214), the computer apparatus 3 determines whether or not the virtual battle is won (step S215). In a case where the virtual battle is won (YES in step S215), the computer apparatus 3 removes the opponent's object from the game field. The computer apparatus 3 changes a region attribute corresponding to the position after the change by the player and secures the changed region attribute (step S216).

In a case where the virtual battle is not won, that is, in a case where the virtual battle ends in a draw or is lost (NO in step S215), the computer apparatus 3 performs a process of finishing the turn. In a case where the virtual battle ends in a draw, both the objects are not removed from the game field. In a case where the virtual battle is lost, the computer apparatus 3 may remove the object on the side of the defeated player from the game field. The removed object may not be usable until the competition game is finished, or a player on a winner side of the virtual battle may use the removed object, as in Shogi.

When regions are secured in step S216 by the change of the position or the winning of the virtual battle, the computer apparatus 3 determines whether or not the regions satisfy the predetermined positional relationship (step S217). With regard to a Reversi effect, it is possible to adopt contents described in the fifth embodiment and FIG. 17 in a necessary range.

In a case where it is determined that the region satisfies the predetermined positional relationship (YES in step S217), a region attribute of the region having the predetermined positional relationship is further changed (step S218). Further, in a case where an opponent's object is present in a region having a changed attribute, a predetermined effect is generated (step S219). The predetermined effect may be a direct effect like an attack against an opponent's object, or may be an auxiliary effect such as a reduction in accuracy rate regarding the attack of the opponent's object. Alternatively, in a case where a friend object is present in the region having a changed attribute, the predetermined effect may be generated in step S219. In this case, a design may be made such that damage to the friend object is reduced or recovered.

Subsequently, the computer apparatus 3 determines whether or not a game finishing condition is satisfied on the basis of the effect generated in step S219 (step S220). In a case where the game finishing condition is satisfied (YES in step S220), the computer apparatus 3 finishes the game without performing the subsequent processing. In a case where the game finishing condition is not satisfied (NO in step S220), the computer apparatus 3 finishes the turn processing. When the player's in-turn process is finished, the opponent player's in-turn process is then started.

Meanwhile, in the above-described flow chart, a description is given of an example in which a player's turn is finished when the position of an object is changed by the player and processing proceeds to an opponent player's turn, but the invention is not limited thereto. For example, a round-based battle may be adopted in which a turn is finished by allowing a position to be changed with respect to all player objects in one turn.

With regard to the virtual battle, it is possible to adopt contents described in the fifth embodiment and FIG. 18 in a necessary range. As an example, a player object associated with a player or a child object associated with an opponent's object associated with an opponent player participates in the virtual battle. With regard to the child object, it is possible to adopt contents described in the fifth embodiment in a necessary range.

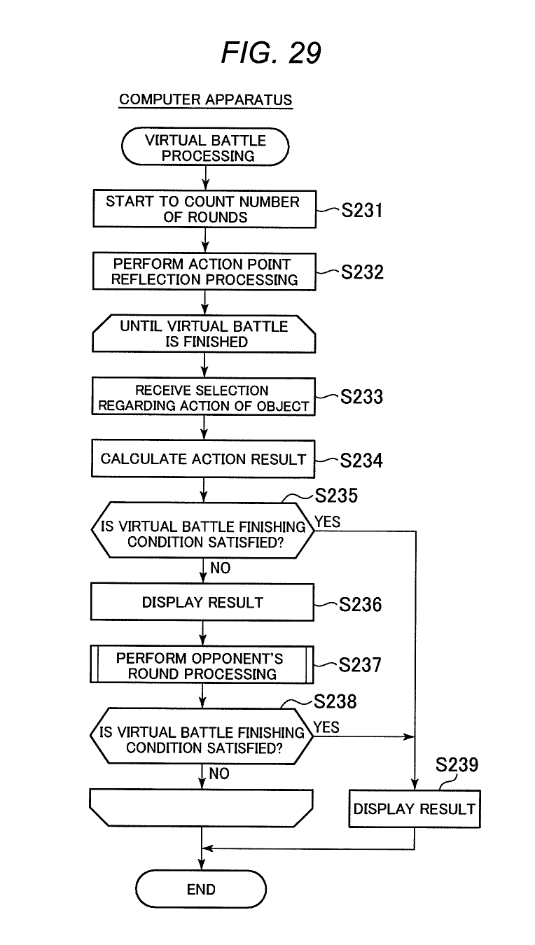

Next, virtual battle processing in the ninth embodiment of the invention will be described. FIG. 29 is a flow chart illustrating virtual battle processing, which corresponds to at least one embodiment of the invention.

First, when a program is executed, the computer apparatus 3 starts to count the number of rounds (step S231). One round is finished when a player and an opponent player alternately perform an operation instruction. Next, an action point, which is a game element used for determination regarding whether or not the child object can act is reflected on a virtual battle screen (step S232). The action point fluctuates depending on the number of regions or the area of the region when the virtual battle is started.

The computer apparatus 3 receives the player's selection regarding the action of the child object (step S233). An option regarding the action of the child object is determined in accordance with an attribute of the child object. With regard to the option regarding the action, it is possible to adopt contents of the action master table described in FIG. 20 in a necessary range.

Subsequently, a result of the action is calculated on the basis of information regarding the action of the child object which is received in step S233 (step S234). In principle, the result of the action is calculated on the basis of parameters of the child object, but a design may be made such that a strong attack occurs in a case where a predetermined condition is satisfied.

Subsequently, the computer apparatus 3 determines whether or not the action result calculated in step S234 satisfies a finishing condition for finishing the virtual battle (step S235). In a case where the action result satisfies the finishing condition (YES in step S235), the computer apparatus 3 displays a result of the virtual battle on the display screen 43 (step S239), and finishes the virtual battle. In a case where the finishing condition is not satisfied (NO in step S235), the computer apparatus 3 displays an action result on the display screen 43 (step S236).

Subsequently, the processing proceeds to round processing of the opponent player (step S237). The round processing of the opponent player includes the processes from step S233 to step S236 which are performed by the opponent player's operation, and thus is omitted. When the round processing of the opponent player is finished, it is determined whether or not the finishing condition for finishing the virtual battle is satisfied (step S238). In a case where the finishing condition is satisfied (YES in step S238), the computer apparatus 3 displays the result of the virtual battle on the display screen 43 (step S239), and finishes the virtual battle. In a case where the finishing condition is not satisfied (NO in step S238), the computer apparatus 3 increments the number of rounds by one, and then performs the processes from step S233 to step S238. The processes from step S233 to step S238 are repeatedly executed until the virtual battle is finished.

The virtual battle may be designed such that a preemptive attack can be performed in accordance with which player's turn a turn performed when starting the virtual battle is. For example, in a case where the virtual battle is started in the player's turn, it is possible to freely make an attack by one round as a preemptive attack, and round processing of a normal virtual battle is then executed. In this manner, the virtual battle can be advantageously progressed by the player who started the virtual battle, and thus it is possible to prevent a passive play in which the virtual battle is avoided on the game field.

In addition to the above-described competition game, it is possible to adopt contents of the communication system described in the fifth embodiment.

As an aspect of the ninth embodiment, a region attribute of a region having a predetermined positional relationship is further changed after the region attribute is changed, thereby generating a predetermined effect. Accordingly, it is possible to change the situation of a competition game in a mode different from that of a virtual battle, which makes it necessary for a player to plan a new strategy, and thus it is possible to provide a strategic and highly interesting game.

As an aspect of the ninth embodiment, an action of an object in a virtual battle is different for each attribute of an object, which makes it necessary for a player to perform a virtual battle in consideration of the action of the object, and thus it is possible to provide a strategic and highly interesting game.

As an aspect of the ninth embodiment, a region to which an object is movable is different for each class of an object, and thus it is possible to progress a competition game by combining rules of movement of objects of a plurality of classes and to provide a strategic and highly interesting game.

As an aspect of the ninth embodiment, an object having being defeated in a virtual battle is removed from a game field, and thus it is possible to greatly change the situation of a competition game and to provide a highly interesting game.

As an aspect of the ninth embodiment, in a case where a region having a region attribute different from that of a region having the changed attribute and a region having the same region attribute as that of the region having the changed attribute are linearly interposed, the region attribute of a region satisfying a predetermined condition may be changed to the same region attribute as that of the changed attribute, so that means for securing the regions can be provided as well as the movement of the object or the victory of the virtual battle, and thus a strategic and highly interesting game can be provided.

As an aspect of the ninth embodiment, a virtual battle is finished with the elapse of a predetermined time or predetermined rounds from the start of the virtual battle, and thus it is possible to smoothly progress a competition game without prolonging the virtual battle.

As an aspect of the ninth embodiment, in a case where a virtual battle is finished with the elapse of a predetermined time from the start of the virtual battle, an object is not removed from a game field. Accordingly, a player avoids the finishing of the virtual battle due to the elapse of time, and thus it is possible to give a motivation to avoid a passive action during the virtual battle.

As an aspect of the ninth embodiment, a reduction in parameters regarding an opponent's object is set to be a virtual battle finishing condition by an attack which is made against the opponent's object through an action of an object, and thus it is possible to give a motivation to more rapidly reduce parameters of the object than those of an opponent.

As an aspect of the ninth embodiment, a configuration is adopted in which an object is associated with a child object. Accordingly, a player can organize a team formed by a combination of a skill and magic of the child object, and it is possible to provide a strategic and highly interesting game.

As an aspect of the ninth embodiment, a parameter of an object is determined on the basis of a parameter of a child object, and thus it is possible to determine the strength of the object in accordance with a combination of child objects, to provide various combinations for each player, and to provide a strategic and highly interesting game.

As an aspect of the ninth embodiment, a competition game is progressed while alternately repeating the change of positions of a player object and an opponent's object, which results in necessity to preread an opponent's next move, and thus it is possible to provide a strategic and highly interesting game.

As an aspect of the ninth embodiment, a special effect which is a particular effect is generated in a case where alternative repetition of the change of positions of a player object and an opponent's object is performed a predetermined number of times, and thus it is possible to provide means for changing the situation of a competition other than a virtual battle and to provide a strategic and highly interesting game.

As an aspect of the ninth embodiment, a game can be finished by setting a parameter of an opponent's object having a predetermined object attribute to equal to or less than a predetermined value, which makes it possible to give a player a motivation to act on the object having a predetermined attribute as an attack target.

As an aspect of the ninth embodiment, an action of an object in a virtual battle is set to be selectable in accordance with the number of regions having a predetermined region attribute or the area of the region, and thus it is possible to give a player a motivation to secure a large number of regions before executing the virtual battle. In addition, a player securing a large number of regions or a region having a wide area can execute a strong action in the virtual battle, which leads to a possibility that the player wins a victory even under a disadvantageous situation, and thus it is possible to provide a strategic and highly interesting game to the player.

As an aspect of the ninth embodiment, a player object and an opponent's object having a predetermined positional relationship participate in a virtual battle, and an action of the player object and/or the opponent's object is set to be selectable in accordance with the number of regions or the area of the region. Accordingly, it is possible to strategically determine an object participating in the virtual battle, and to provide a strategic and highly interesting game in which, for example, an object is involved, having a predetermined object attribute determined under game finishing conditions.

In the ninth embodiment, with regard to each of the “competition game”, the “computer apparatus”, the “progress”, the “field”, the “region”, the “region attribute”, and the “event”, it is possible to adopt contents described in the first embodiment in a necessary range. With regard to each of the “object” and the “opponent's object”, it is possible to adopt contents described in the second embodiment in a necessary range. With regard to each of the “predetermined action” and the “game element”, it is possible to adopt contents described in the third embodiment in a necessary range. In the ninth embodiment, with regard to each of the “object attribute”, the “child object”, and the “special effect”, it is possible to adopt contents described in the fifth embodiment in a necessary range.

### APPENDIX

The above-described embodiments have been described so that those skilled in the art can implement the following invention.

[1] A game program for executing a competition game in a server apparatus which is communicatively connected to a computer apparatus including an input apparatus, the game program causing the server apparatus to function as:

an attribute changer that changes a region attribute of at least one region among a plurality of regions included in a game field, in accordance with progress of the game;

an event generator that generates an event during the progress of the game; and

an event processor that progresses the event in accordance with the number of regions having a predetermined region attribute or an area of the region.

[2] The game program according to [1], causing the server apparatus to further function as:

a position changer that changes positions of objects including a player object associated with a player and an opponent's object playing a competition with the player object, which are present on the game field,

wherein the event generator generates the event in a case where the player object and the opponent's object have a predetermined positional relationship.

[3] The game program according to [1] or [2],

wherein the event processor causes the object present on the game field to participate in the event and progresses the event, and

wherein the event processor further includes a game element setter that sets a game element which is used to determine whether or not the object is capable of executing a predetermined action in the event, in accordance with the number of regions having the predetermined region attribute or the area of the region.

[4] The game program according to [2] or [3],

wherein the attribute changer includes

a first attribute changer that changes a region attribute of a region corresponding to the position of the object which is changed by the position changer, and

a second attribute changer that changes a region attribute of a region having a region attribute different from the region attribute changed by the first attribute changer, in a case where the region satisfies a predetermined condition.

[5] The game program according to [4], causing the server apparatus to further function as:

an effect generator that generates a predetermined effect for the object in a case where the object is present in the region having the region attribute changed by the second attribute changer.

[6] The game program according to any one of [3] to [5], causing the server apparatus to further function as:

an action memory that stores an action to be executed by the object in the event, in association with an object attribute of the object,

wherein an action different for each object attribute is executable in the event.

[7] The game program according to [6],

wherein only a position having a predetermined positional relationship from a position before change is determined for each object attribute, as a position which is changeable by the position changer.

[8] The game program according to any one of [1] to [7], causing the server apparatus to further function as:

an object remover that removes at least one object, which is present on the game field, from the game field in accordance with a result of the event.

[9] The game program according to any one of [4] to [8],

wherein the predetermined condition in the second attribute changer is a condition in which a region having a region attribute different from the region attribute changed by the first attribute changer is linearly interposed between the region having the region attribute changed by the first attribute changer and a region having the same region attribute as the changed region attribute of the region, and

wherein the second attribute changer changes a region attribute of a region satisfying the predetermined condition to the same region attribute as the region attribute changed by the first attribute changer.

[10] The game program according to any one of [1] to [9],

wherein the event processor includes an event finisher for finishing the event in a case where a predetermined event finishing condition is satisfied.

[11] The game program according to [10],

wherein the predetermined event finishing condition in the event finisher is a condition in which a predetermined time elapses after the event is started.

[12] The game program according to [11],

wherein the object is not removed from the game field in a case where the event is finished with the elapse of the predetermined time after the event is started.

[13] The game program according to any one of [10] to [12],

wherein the event processor progresses the event by repeating execution of an action by the player object and the opponent's object in accordance with a predetermined rule, and

wherein the predetermined event finishing condition in the event finisher is a condition in which the number of times of the repetition of the execution of the action by the player object and the opponent's object according to the predetermined rule reaches a predetermined number of times.

[14] The game program according to any one of [10] to [13],

wherein the object has a first parameter which is an object parameter,

wherein the first parameter of the object or another object different from the object changes in accordance with an action of the object in the event, and

wherein the predetermined event finishing condition in the event finisher is a condition in which the first parameter of at least one object is set to be equal to or less than a predetermined value.

[15] The game program according to any one of [2] to [14],

wherein the object includes one or more child objects.

[16] The game program according to [15],

wherein the first parameter of the object is determined on the basis of a second parameter of the child object included in the object.

[17] The game program according to any one of [2] to [16],

wherein the position changer alternately repeats change of positions of the player object and the opponent's object.

[18] The game program according to [17], causing the server apparatus to further function as:

a special effect generator that generates a special effect which is a particular effect, in a case where the alternative repetition of the change of the positions of the player object and the opponent's object by the position changer is performed a predetermined number of times.

[19] The game program according to any one of [1] to [18],

wherein the game processor includes a game finisher that finishes the competition game in a case where a predetermined game finishing condition is satisfied.

[20] The game program according to [19],

wherein the predetermined game finishing condition in the game processor is a condition in which the first parameter of the opponent's object having a predetermined object attribute of the object is set to be equal to or less than a predetermined value.

[21] The game program according to any one of [2] to [20],

wherein the object, which is present on the game field, participates in the event generated by the event generator, and

wherein the event processor includes a selectable setter that selectively sets the action of the object in the event, in accordance with the number of regions having the predetermined region attribute or the area of the region.

[22] The game program according to any one of [2] to [21],

wherein the player object and the opponent's object having the predetermined positional relationship participate in the event generated by the event generator, and

wherein the event processor includes a selectable setter that selectively sets the action of the player object and/or the opponent's object, in accordance with the number of regions having a predetermined region attribute or the area of the region.

[23] A server apparatus in which the program according to [1] is installed.

[24] A system comprising:

a computer apparatus that includes an input apparatus;

a server apparatus which is communicatively connected to the computer apparatus;

an attribute changer that changes a region attribute of at least one region among a plurality of regions included in a game field, in accordance with progress of a game;

an event generator that generates an event during the progress of the game; and

an event processor that progresses the event in accordance with the number of regions having a predetermined region attribute or an area of the region.

[25] A game program for executing a competition game in a computer apparatus which includes an input apparatus and is communicatively connected to a server apparatus, the game program causing the computer apparatus to function as:

a control instruction receiver that receives a player's control instruction,

wherein the server apparatus changes a region attribute of at least one region among a plurality of regions included in a game field in accordance with progress of the game, generates an event during the progress of the game, and progresses the event in accordance with the number of regions having a predetermined region attribute or an area of the region.

[26] A computer apparatus in which the program according to [25] is installed.

[27] A method of progressing a competition game which is executed in a server apparatus which is communicatively connected to a computer apparatus including an input apparatus, the method comprising:

changing a region attribute of at least one region among a plurality of regions included in a game field, in accordance with progress of the game;

generating an event during the progress of the game; and

progressing the event in accordance with the number of regions having a predetermined region attribute or an area of the region.

[28] A method of progressing a competition game which is executed in a system including a computer apparatus that includes an input apparatus and a server apparatus which is communicatively connected to the computer apparatus, the method comprising:

changing a region attribute of at least one region among a plurality of regions included in a game field, in accordance with progress of the game;

generating an event during the progress of the game; and

progressing the event in accordance with the number of regions having a predetermined region attribute or an area of the region.

[29] A game program for executing a competition game in a computer apparatus including an input apparatus, the game program causing the computer apparatus to function as:

an attribute changer that changes a region attribute of at least one region among a plurality of regions included in a game field, in accordance with progress of the game;

an event generator that generates an event during the progress of the game; and

an event processor that progresses the event in accordance with the number of regions having a predetermined region attribute or an area of the region.

[30] A computer apparatus functioning as:

an attribute changer that changes a region attribute of at least one region among a plurality of regions included in a game field, in accordance with progress of a game;

an event generator that generates an event during the progress of the game; and

an event processor that progresses the event in accordance with the number of regions having a predetermined region attribute or an area of the region.

[31] A method of progressing a competition game executed in a computer apparatus including an input apparatus, the method comprising:

changing a region attribute of at least one region among a plurality of regions included in a game field, in accordance with progress of the game;

generating an event during the progress of the game; and

progressing the event in accordance with the number of regions having a predetermined region attribute or an area of the region.

1. A non-transitory computer-readable recording medium including a game program for executing a competition game in a server apparatus which is communicatively connected to a computer apparatus including an input apparatus, the game program causing the server apparatus to function as:
an attribute changer that changes a region attribute of at least one region among a plurality of regions included in a game field, in accordance with progression state of the game;
an event generator that generates an event during the progress of the game; and
an event processor that progresses the event in accordance with the number of regions having a predetermined region attribute or an area of the region.

2. The non-transitory computer-readable recording medium according to claim 1, causing the server apparatus to further function as:
a position changer that changes positions of objects including a player object associated with a player and an opponent's object playing a competiton with the player object, which are present on the game field,
wherein the event generator generates the event in a case where the player object and the opponent's object have a predetermined positional relationship.

3. The non-transitory computer-readable recording medium according to claim 1,
wherein the event processor causes the object present on the game field to participate in the event and progresses the event, and
wherein the event processor further includes a game element setter that sets a game element which is used to determine whether or not the object is capable of executing a predetermined action in the event, in accordance with the number of regions having the predetermined region attribute or the area of the region.

4. The non-transitory computer-readable recording medium according to claim 2,
wherein the attribute changer includes
a first attribute changer that changes a region attribute of a region corresponding to the position of the object which is changed by the position changer, and
a second attribute changer that changes a region attribute of a region having a region attribute different from the region attribute changed by the first attribute changer, in a case where the region satisfies a predetermined condition.

5. The non-transitory computer-readable recording medium according to claim 4, causing the server apparatus to further function as:
an effect generator that generates a predetermined effect for the object in a case where the object is present in the region having the region attribute changed by the second attribute changer.

6. The non-transitory computer-readable recording medium according to claim 3, causing the server apparatus to further function as:
an action memory that stores an action to be executed by the object in the event, in association with an object attribute of the object,
wherein an action different for each object attribute is executable in the event.

7. A system comprising:
a computer apparatus that includes an input apparatus;
a server apparatus which is communicatively connected to the computer apparatus;
an attribute changer that changes a region attribute of at least one region among a plurality of regions included in a game field, in accordance with progression state of a game;
an event generator that generates an event during the progress of the game; and
an event processor that progresses the event in accordance with the number of regions having a predetermined region attribute or an area of the region.

8. A non-transitory computer-readable recording medium including a game program for executing a competition game in a computer apparatus which includes an input apparatus and is communicatively connected to a server apparatus,
wherein the server apparatus changes a region attribute of at least one region among a plurality of regions included in a game field in accordance with progression state of the game, generates an event during the progress of the game, and progresses the event in accordance with the number of regions having a predetermined region attribute or an area of the region and,
the game program causing the computer apparatus to function as an operation instruction receiver that receives a player's operation instruction.

9. The non-transitory computer-readable recording medium according to claim 6,
wherein only a position having a predetermined positional relationship from a position before change is determined for each object attribute, as a position which is changeable by the position changer.

10. The non-transitory computer-readable recording medium according to claim 1, causing the server apparatus to further function as:
an object remover that removes at least one object, which is present on the game field, from the game field in accordance with a result of the event.

11. The non-transitory computer-readable recording medium according to claim 4,
wherein the predetermined condition in the second attribute changer is a condition in which a region having a region attribute different from the region attribute changed by the first attribute changer is linearly interposed between the region having the region attribute changed by the first attribute changer and a region having the same region attribute as the changed region attribute of the region, and
wherein the second attribute changer changes a region attribute of a region satisfying the predetermined condition to the same region attribute as the region attribute changed by the first attribute changer.

12. The non-transitory computer-readable recording medium according to claim 1,
wherein the event processor includes an event finisher for finishing the event in a case where a predetermined event finishing condition is satisfied.

13. The non-transitory computer-readable recording medium according to claim 12,
wherein the predetermined event finishing condition in the event finisher is a condition in which a predetermined time elapses after the event is started.

14. The non-transitory computer-readable recording medium according to claim 13,
wherein the object is not removed from the game field in a case where the event is finished with the elapse of the predetermined time after the event is started.

15. The non-transitory computer-readable recording medium according to claim 12,
wherein the event processor progresses the event by repeating execution of an action by the player object and the opponent's object in accordance with a predetermined rule, and
wherein the predetermined event finishing condition in the event finisher is a condition in which the number of times of the repetition of the execution of the action by the player object and the opponent's object according to the predetermined rule reaches a predetermined number of times.

16. The non-transitory computer-readable recording medium according to claim 12,
wherein the object has a first parameter which is an object parameter,
wherein the first parameter of the object or another object different from the object changes in accordance with an action of the object in the event, and
wherein the predetermined event finishing condition in the event finisher is a condition in which the first parameter of at least one object is set to be equal to or less than a predetermined value.

17. The non-transitory computer-readable recording medium according to claim 2,
wherein the object includes one or more child objects.

18. The non-transitory computer-readable recording medium according to claim 17,
wherein the first parameter of the object is determined on the basis of a second parameter of the child object included in the object.

19. The non-transitory computer-readable recording medium according to claim 2,
wherein the position changer alternately repeats change of positions of the player object and the opponent's object.

20. The non-transitory computer-readable recording medium according to claim 19, causing the server apparatus to further function as:
a special effect generator that generates a special effect which is a particular effect, in a case where the alternative repetition of the change of the positions of the player object and the opponent's object by the position changer is performed a predetermined number of times.
